(19) United States
(12) Patent Application Publication
(10) Pub. No.: US 2008/0232885 A1
(43) Pub. Date: Sep. 25, 2008

(54) Systems and Methods for Creating Customized Activities

(75) Inventors: Stephen Mock, Henderson, NV (US); Angel C. Kuo, Las Vegas, NV (US)

Correspondence Address: Chad R. Walsh;Fountainhead Law Group P.C., Suite 509, 900 Lafayette St., Santa Clara, CA, 95050, US

(73) Assignee: Giftventure Studios, Inc., Henderson, NV (US)

(21) Appl. No.: 12/050,788

(22) Filed: Mar. 18, 2008

Related U.S. Application Data
(60) Provisional application No. 60/919,069, filed on Mar. 19, 2007.

(51) Int. Cl. B41J 11/44

(52) U.S. Cl. 400/76

(57) ABSTRACT

Embodiments of the present invention include systems and methods for creating customized activities. In one embodiment, the present invention includes a method comprising storing a plurality of activity records, storing a plurality of text elements, storing a plurality of template letters with fillable fields, receiving a plurality of customized text elements from a user and a selection of an activity record, associating template letters with the activity, and associating text elements and customized text with the activity to generate customized correspondence. For example, in one embodiment a print control document is generated for printing customized mailers. In one embodiment, the system receives a message and encodes the message. The message may be the location of a hidden gift, for example. The print control document may include the encoded message and the encoded message is included in at least one of the mailers.

### CROSS REFERENCE TO RELATED APPLICATIONS

This invention relates to and claims priority from U.S. Provisional Patent Application No. 60/919,069 filed Mar. 19, 2007 naming Stephen Mock as inventor.

### BACKGROUND

The present invention relates to a computer-implemented systems and methods for creating customized activities.

The growth and prevalence of computer systems and networks, including the Internet, has opened up a new dimension of entertainment and activities for users. For example, computer based games, communications, and activities have seen a rapid growth as more and more users discover the Internet. However, activities that are entirely based on computer systems often fall short. For most people, a healthy balance between real life activities such as scavenger hunts, physical puzzles, and other “real life” activities is needed. For example, many parents do not find it altogether desirable that their children spend increasing amounts of time in front of the computer, and would rather have children engaged in real world activities.

Currently, there is a strict partition between computer based activities that take place entirely in a virtual world and real life activities that take place in the physical world (the real world). The virtual world is free from physical constraints, and allows users almost unlimited flexibility and freedom of imagination to create an unlimited number of experiences. However, these experiences are only virtual. They are not real. The physical world on the other hand is limited by physical constraints, but offers users physical engagement, which can be far more rewarding in many ways that the virtual world cannot provide. What is needed is a creative solution for bridging the virtual world and physical world, so that the flexibility and freedom of imagination in the virtual world can be manifested in physical form and thereby create an enhanced combined experience.

Thus, there is a need for the improved systems and methods for creating activities and experiences across the virtual and physical domains. The present invention solves these and other problems by providing systems and methods for creating customized activities.

### SUMMARY

Embodiments of the present invention include systems and methods for creating customized activities. In one embodiment, the present invention includes a method for generating and coordinating activities electronically on a computer system and generating customized mailers for the activities.

In one embodiment, the present invention includes a computer-implemented method comprising storing a plurality of activity records, storing a plurality of first text elements, storing a plurality of template letters, each template letter including a plurality of fillable fields, receiving a plurality of customized text elements from a user and a selection of a first activity record from said plurality of activity records, associating a plurality of said template letters with the first activity, associating one or more of said first text elements and said customized text elements with the first activity, and generating a print control document for controlling the printing of said template letters, wherein the one or more first text elements and the customized text are used to fill the fields of the template letters.

In one embodiment, the system receives a message and includes the message in the print controls. In one embodiment, the message is encoded. In another embodiment, the message is a location. The print control document may include the encoded location and the encoded location is included in one or more printed mailers.

In another embodiment, the system may generate electronic communications to a recipient such as emails, text messages, or IM messages, for example. Accordingly, a series of materials, letters, website landing pages, phone calls, text messages, IM messages, real-world props, etc., may be dynamically generated and sent to the recipient of the adventure over a period of time.

The following detailed description and accompanying drawings provide a better understanding of the nature and advantages of the present invention.

### BRIEF DESCRIPTION OF THE DRAWINGS

FIG. 1 illustrates a system according to one embodiment of the present invention.

FIG. 2 illustrates a server system according to one embodiment of the present invention.

FIG. 3 illustrates a method of generating customized activities according to one embodiment of the present invention.

FIG. 4 illustrates a printer control document according to one embodiment of the present invention.

FIG. 5 illustrates the components of an example activity according to one embodiment of the present invention.

FIG. 6 illustrates character components according to one embodiment of the present invention.

FIG. 7 illustrates a method of generating customized mailers for an adventure according to one embodiment of the present invention.

FIG. 8 illustrates a standard individual delivery process according to one embodiment of the present invention.

FIG. 9 illustrates a packaged delivery process according to one embodiment of the present invention.

FIGS. 10A-B illustrate example calendars for scheduling mailings according to one embodiment of the present invention.

FIG. 11 is an example of an administration architecture according to one embodiment of the present invention.

FIGS. 12A-G are example of activity components according to one embodiment of the present invention.

FIG. 13 is an example of records mapped to fillable fields in a template letter according to one embodiment of the present invention.

FIG. 14 illustrates entering a message according to another embodiment of the present invention.

FIG. 15 illustrates a method including encoding a message according to another embodiment of the present invention.

FIGS. 16A-G are examples of encoded location messages for different puzzles according to different embodiments of the present invention.

FIG. 17 illustrates an example schema for a printer control document according to one embodiment of the present invention.

FIGS. 18A-E illustrates an example schema for a repository according to one embodiment of the present invention.

FIG. 19 illustrates computer system according to one embodiment of the present invention.

### DETAILED DESCRIPTION

Described herein are techniques for creating customized activities. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

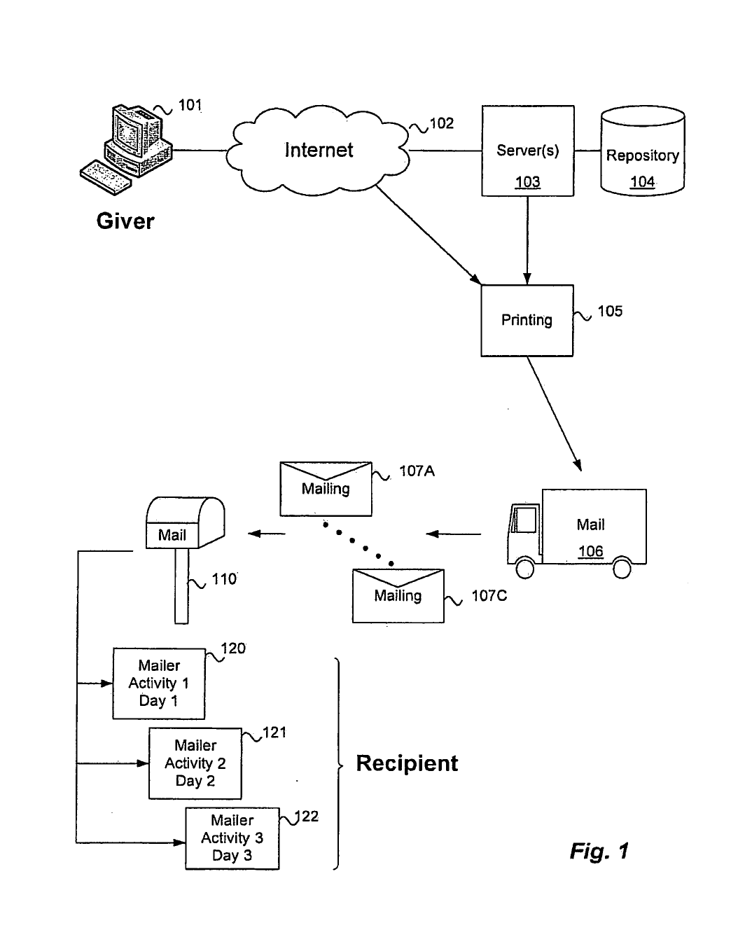

FIG. 1 illustrates a system according to one embodiment of the present invention. Features and advantages of the present invention include creating dynamic activities virtually and manifesting the activities in the real world. In this example, a user of a computer 101 (i.e., a giver) may select and customize an activity for a recipient. An activity is used here in the context of a computer implemented specification that is translated (e.g., printed) into materials that may be used for real world activities in the physical world (e.g., scavenger hunts, physical puzzles, or role playing such as a mystery dinner party). The specification of the activity may be componentized so that the activity is highly configurable, for example. Here a user may use computer 101 to access a server 103 over a network, such as the Internet 102, to make a gift of the activity to another person (the recipient). It is to be understood that the features and techniques described herein may be implemented on one server or several servers. Here, server 103 sends computer 101 information describing the activities and customizations that are available, and the user selects the desired activities and enters customized data into the server to configure the activity for the specific recipient. Data about the activities and associated customizations may be stored in a repository 104, for example. One example embodiment of the present invention includes an innovative interface for linking information in the server 103 and/or database 104 with a printing system 105. Printing system 105 may receive information corresponding to the selected activity and user entered customizations for the recipient and generate printed mailings. In other embodiments, customized activities may sent to recipients using an electronic communication such as email, text messaging, or SMS for example. In the embodiment illustrated in FIG. 1, a printer control document comprising a plurality of records each corresponding to a specific customized activity mailer to be printed and mailed is sent from the server to the printing system. The customized printed mailings (or deliveries) may be sent through any delivery service, including the mail, to the recipient. In this example, mailings 107A through 107C are sent to a recipient through the mail, and may be delivered to a recipient's mailbox 110. In this case, the recipients mailing address may be included as data entered by the giver into the system. The mailings may be delivered all at once and opened in different prescribed orders, or the mailings may be delivered across several consecutive or nonconsecutive days (e.g., sequentially). Here, a recipient receives a customized mailer 120 with a first customized activity 1 on day 1. On another day (day 2), which may be the next day or many days later, the recipient receives a second customized mailer 121 with a second customized activity. On yet another day (day 3) the recipient receives a third customized mailer 122 with a third customized activity. The automated customized printed mailers may lead the recipient, mailer by mailer, through a wide range of activities and may incorporate graphics and content maintained and managed by the system, thereby bridging the real world with the virtual world. While the examples provided below describe embodiments of the invention using adventures with associated characters, letters, and puzzles, it is to be understood that the concepts describe herein could be applied to a wide range of applications bridging virtual and real worlds.

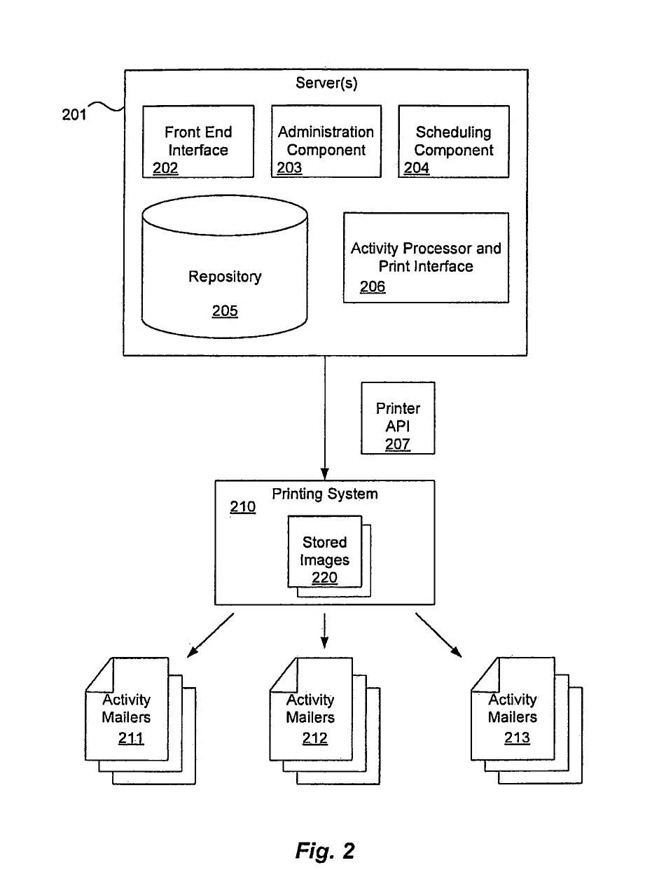

FIG. 2 illustrates a server system according to one embodiment of the present invention. Server system 201 may include one or more servers for implementing the functionality described herein. In this example, server 201 includes a front end interface 202 for generating and sending web pages with customizable activities to users and receiving a user's (a giver's) selections for activity options, data about the recipient for use in customizing the activity, and other parameters specific to the recipient and selected activity for further customization. The server may store data in repository 205. Repository 205 may include data corresponding to specific activities, data corresponding to customizable mailers, giver data, recipient data, data about specific options available for association with an activity for further customization, data about scheduling, graphics for use in printing the activities, and a variety of other data used to implement the concepts described herein. Server 201 may also include an administrative component 203, a scheduling component 204, and an activity processor and print interface 206. Features and advantages of the present invention may include the ability to flexibly define (e.g., by third parties) new activities that may be offered to givers and recipients through server 201. For instance, a new activity may be defined, uploaded, and integrated into the system using the administrator, thereby allowing a wide range of developers to create and integrate an almost unlimited number of activities for the system. As described in more detail below, one activity contemplated by the present invention is an adventure including associated characters, templates, graphics, puzzles, and other printable matter. Administration component 203 may be used to integrate new adventures, new characters, new templates, new graphics, and new puzzles developed separately by third party developers. Server 201 further includes a scheduling component 204 for automatically optimizing the scheduled printing and delivery of mailers. For example, as described in more detail below users may select dates for delivery of one or more mailers for a given activity. Scheduler 204 may selectively schedule the dates on which different activities are printed and sets the mailer frequencies (e.g., mail delivery specifications) of each activity to optimize the costs of printing. Scheduler 204 may include a calendaring system and tracking system for scheduling and tracking printing and delivery of each mailer in each activity. Activity processor and printer interface may access data from repository 205, including activity data, customization data, data about a giver, data about a recipient, and generate a printer application program interface (“API”) 207, which provide print controls for printing and generating mailers. For example, in one embodiment described in more detail below, activity data may include puzzles. A giver may enter customization data, such as the location of a gift to be presented to the recipient, and component 206 may encode the location in one or more puzzles so that the recipient, upon completing the puzzle will also decode the location of the gift and discover where the gift is hidden. Printer API 207 may include the recipient's address, a specification of the activity, customization data, a specification of one or more graphics to be printed, a mailing date, and other information for generating customized mailers corresponding to an activity for a specified recipient. For example, in one embodiment, the printer API may include a plurality of data records each including a field with a specification of a text template to be printed corresponding to a giver selected activity, the text template including a plurality of data fields to be filled, a plurality of fields each with giver entered customized text for use with the plurality of data fields to be filled in the text template (i.e., so that the number of data fields in the text template is equal to the number of field with customized text), one or more fields with a specification of giver selected graphics to print on the same material as the template, one or more fields with a specification of an activity associated graphics to print on another material to be mailed with the template, and in some activities one or more fields specifying a static encoded representation of a location of an item (e.g., a gift), where the encoded representation is printed on a piece of materials sent to the recipient in one of the mailings.

As illustrated in FIG. 2, the printer API may be sent to a printing system 210 and used to print mailers. For instance, the printer API may be received by printing system 210. The printing system may include stored images 220. The printer API may specify the pre-stored images on the printing system to use for printing and may specify the text to print, for example. In FIG. 2, a plurality of different activity mailers may be printed on different days in batches. Each activity mailer may include a customized letter associated with the giver selected activity with user selected text entries and graphics also associated with the giver selected activity, one or more printed graphics associated with the activity, wherein some printed graphics include encoded information such as the location of a gift, for example. Different mailers to different recipients for different activities may be mailed on specified days using the printer API. For example, activity mailers 211 may include a first mailing of a first activity to a first recipient, a second mailing of a second activity to a second recipient, a second mailing of the first activity to a third recipient, and any other mailings for all available activities to multiple other recipients. The mailings are batched to print for mailing on specified days of the week, which in turn sets the mail frequency of each activity. By setting the mail frequency of each mailer in each activity based on specified days, all activity mailers can be batched and a single printer API may be generated for printing and mailing activities together on specified days. This results in economies of scale in printing and advantageously reduced costs. Similarly, activity mailers 212 may be batch printed and mailed on another specified day, and activity mailers 213 may be batch printed and mailed on yet another specified day.

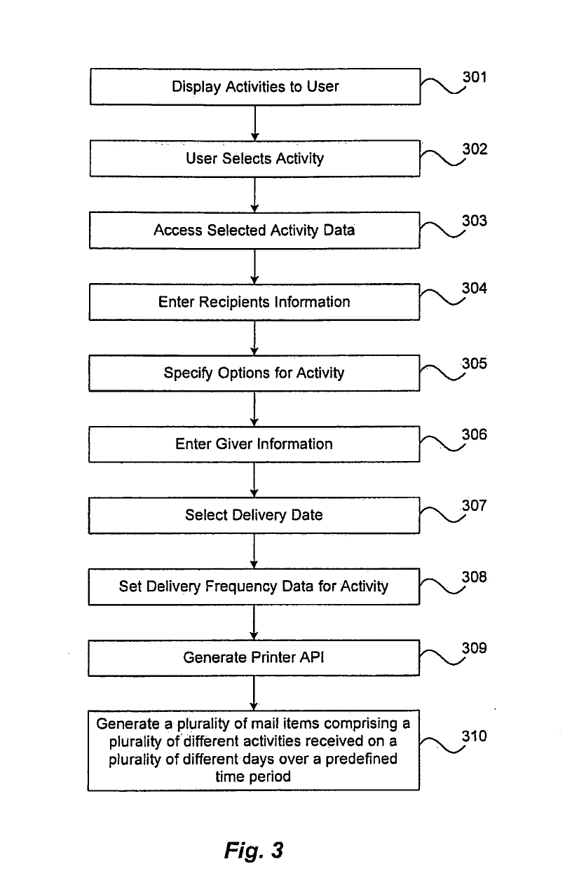

FIG. 3 illustrates a method of generating customized activities according to one embodiment of the present invention. At 301 a user may access the front end of server system 210 and the server may display activities for selection. At 302, the user (e.g., a giver) may select the desired activity for a recipient. At 303, activity data for the selected activity is accessed. Activity data may include information describing the activity, examples of printed materials that are mailed as part of the activity, mailing frequencies, and associated features and customization options for the activity. At 304, the giver enters the recipient's information, such as name, address, and information specific to or about the recipient (e.g., the recipient's likes or dislikes, friends, points of interest, or other information known by and familiar to the recipient). At 305, the giver may specify options for the activity. For instance, the activities may be componentized so that different activity components may be selected and customized for the particular recipient (e.g., by gender, age, genre or theme of interest). Examples may include activities that include components with mystery themes, fantasy themes, or science fiction themes, which may have different character components or puzzles components based on the recipients interests. At 306, the user enters information about the giver (e.g., name, email, address). At 307, the delivery date may be selected based on a limited number of predefined printing days or dates. At 308, the delivery frequency data for the selected activity is determined based on the selected date and predefined printing days or dates. For instance, an activity may have three (3) mailings, with the selectable predefined mail dates being Tuesdays and Thursdays so that if the user selects a Thursday for the first mailing, a printer API will be generated that includes the user's activity information on the selected Thursday, a second printer API with the second mailing for the user's selected activity is generated for printing five (5) days after the first mailing (e.g., the next Tuesday), and a third printer API with the third mailing for the user's selected activity is generated for printing two (2) days after the second mailing (e.g., the following Thursday). In this example, the mailing frequency is {5, 2} based on the specified printing days. Since some activities will include multiple mailings, features and advantages of the present invention may advantageously determine and track the printing schedules for numerous activity mailers for different stages of numerous activities. At 309, the printer API is generated. At 310, a plurality of mail items comprising a plurality of different activities received on a plurality of different days over a predefined time period are generated.

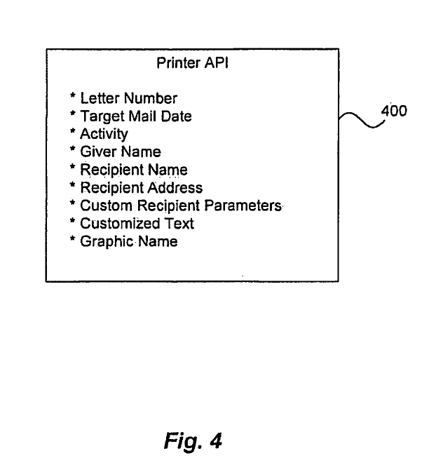

FIG. 4 illustrates a printer control document according to one embodiment of the present invention. Printer control document 400 may include a plurality of records each corresponding to a specific customized activity mailer to be printed and mailed. In this example, each record includes a letter number indicating which letter in a sequence of letters mailed as part of an activity the current mailing corresponds to, a target mailing date indicating the batch printing and mailing date, the name of the activity, the giver's name, the recipient's name, the recipient's address, custom parameters specific to the particular recipient, one or more fields of customized text to fill fields in the template text associated with the activity, and one or more graphic names.

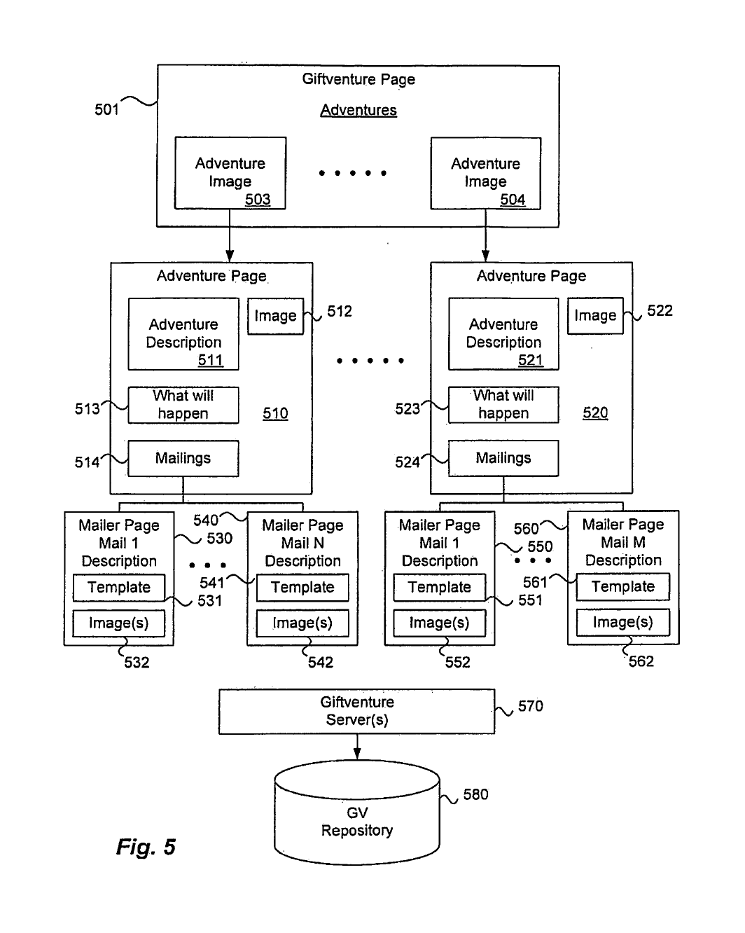

FIG. 5 illustrates the components of an example activity according to one embodiment of the present invention. One example activity that may be provided by the present invention are a plurality of different adventures each including letter templates associated with the adventure, graphics of puzzles associated with the adventure, giver selectable characters, and graphics associated with the characters. A giver may select, customize, and give a Giftventure™ to a recipient that may cause the recipient to receive a customized sequence of printed letters and puzzles from a virtual character created and stored in virtual reality (i.e., on a computer system). A variety of customizable componentized adventures may be available. For instance, a user may access a webpage 501 which may show the adventures available for sending to a recipient. In this example, graphic images of available adventures 503 and 504 may illustrate the adventures for a user to select. The images may each be hypertext links leading to other pages for displaying adventure specific information. If a user selects adventure image 503, the adventure page 510 may be accessed and sent to the user. Adventure page 510 may include a description of the adventure 511, an image of the adventure 512, and a link to a “What will happen” page 513 and a link 514 to a Mailings page.

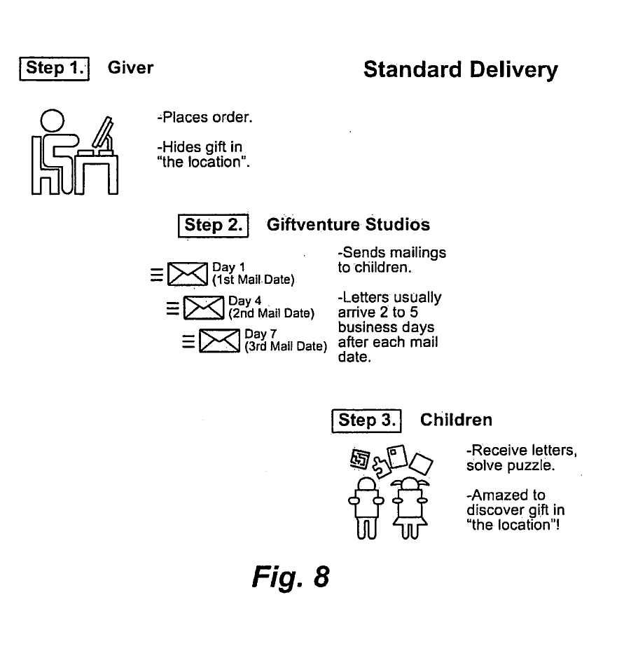

The “What will happen” page may describe how the adventure works. For example, a “The Treasure Map Adventure” may be described as an adventure that includes 3 mailings that lead to the discovery of a gift hidden by the giver at a predetermined location entered into the system. A description may further indicate that the giver may choose a location to hide a gift and enter “the location” into the system when you order the adventure. The description may further indicate to the user that the system will create and send the mailings with a customized puzzle where the answer is the location that was entered. Furthermore, the system may present the user with two delivery options for the adventure product. Embodiments of the present invention may include a standard delivery, where the system sends the mailers individually and directly to the recipient, typically one sent every few days. This option may be selected when an exact end date for completing the adventure is not necessary. A standard individual delivery process is illustrated in FIG. 8. As illustrated in FIG. 8, a giver places an order by selecting an adventure and entering data including customization data for the recipient (e.g., a child). The giver may hide a gift in a specified location. The system then processes the entered data and generates printer control documents to cause a printing system to send a plurality of mailings to the recipient. For example, the letters may arrive 2 to 5 business days after each mail date. The recipients may receive a letter and puzzle with each mailing, and work to solve the puzzles. The letters and puzzles progressively lead the recipient to discover the location of the hidden gift.

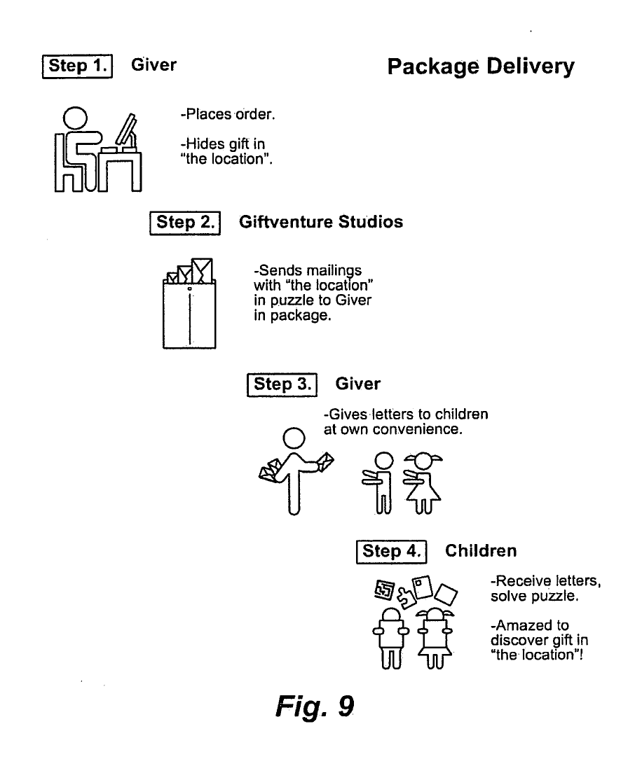

Alternatively, the system may include a package delivery, where the system sends all of the mailers in a single package to the giver or a designated third party (e.g., someone proximate to the recipient). The letters may be distributed according to a user controlled timeline and finish the adventure at the convenience of the giver, the recipient, or a third party. A package delivery process is illustrated in FIG. 9. As illustrated in FIG. 9, a giver places an order by selecting an adventure and entering data including customization data for the recipient and the giver may hide a gift in a specified location. The system then processes the entered data and generates a single printer control documents to cause a printing system to send a plurality of mailings addressed to the recipient, but inside a package addressed the giver or a designated third party. The giver then distributes the letters as if they had been addressed to the recipients. The recipients may receive a letter and puzzle with each mailing, and work to solve the puzzles. The letters and puzzles progressively lead the recipient to discover the location of the hidden gift. Such an approached may be used when an exact end date is desired (birthdays, specific holidays, relative visit etc.). Accordingly, in a standard individual delivery, the mailings may be printed on different days using different printer APIs and mailed to the recipient, but in a packaged delivery all the mailings are printed in a single printing addressed to the recipient and mailed together in a separate package addressed to the giver or a designated third party.

Referring again to FIG. 5, users may be able to access pages for each mailer associated with an adventure. For example, a plurality of mailer pages 530 through 540 may be associated with adventure 510. Similarly, a plurality of mailer pages 550 through 560 may be associated with adventure 520. Mailer pages may each illustrate information about one of the mailers associated with a selected adventure. Mailer page 1 may include a text template 531 for one of the mailers with a plurality of fields to be filled in with customized information for the recipient and one or more images 532 based on adventure options selected by the giver. For example, each adventure may have one or more associated characters with corresponding character data. Character data may include some of the customized data to be filled in based on a limited set of characters associated with the adventure (e.g., “Hello, my name is <<fillable field>>.”<<fillable field>>={Capt. Percy, Fay the Princess, Gunther the Dragon}). Similarly, each associated character may have corresponding graphic images to be printed on one or both sides of each specific letter to be mailed. Furthermore, each adventure mailing may have an associated graphic image to be printed and mailed with the different filled in letters, such as a map, cipher, or other puzzle, for example. These images corresponding to each mailer may be displayed on the mailer pages. All of this information may be stored in a repository 580 and accessed by a server 570. For example, as described in more detail below, each adventure (a product or activity) may be stored as a record in a database with associated attributes in fields of the record (e.g., name, character, price, mailers, images). This data may be used for presenting the adventure to a user and for generating the printer control document used to generating the mailings for the adventure.

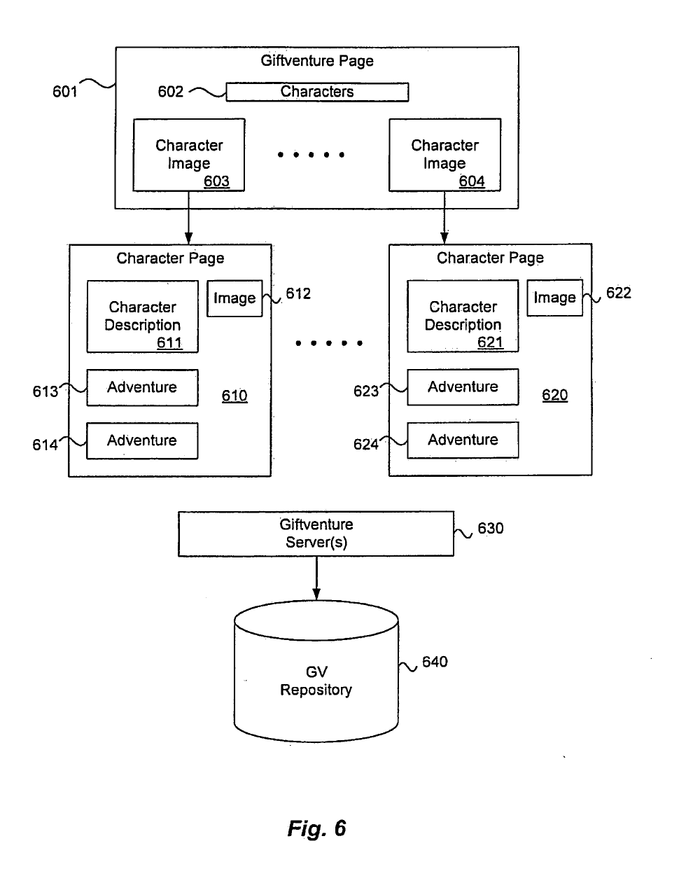

FIG. 6 illustrates character components according to one embodiment of the present invention. Embodiments of the present invention may allow users to view and even add in different characters to be associated with an adventure. For example, a characters page 601 may show all the characters available on the system. Each character may be presented in different graphic images 603 through 604, which may also be links to character pages for each individual character. Character page 610 may include a text description of the character 611, an image of the character 612, and a listing of adventures 613 through 614 that the character is associated with. Character data may be stored in repository 640 and accessed by server 630. For example, as describe in more detail below, each character (or other customizable component of an activity) may be stored as a record in a database with associated attributes in fields of the record (e.g., name, text description, and character image). This data may be used for presenting the character to a user and for generating the printer control document used to generating the mailings for the character when the character is associated with an adventure.

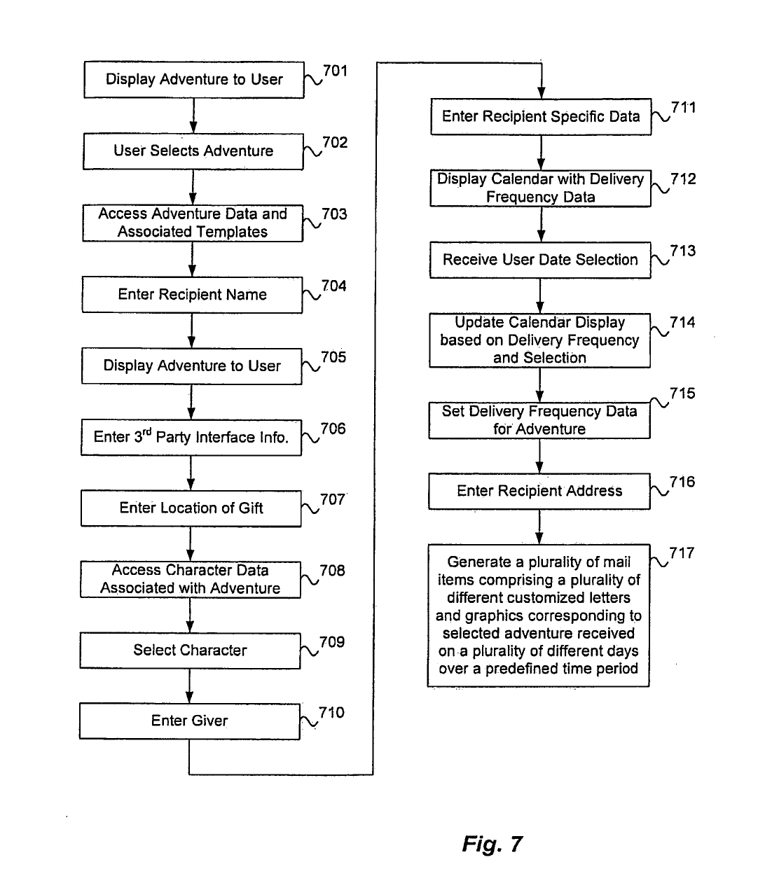

FIG. 7 illustrates a method of generating customized mailers for an adventure according to one embodiment of the present invention. At 701 a user (e.g., a giver) accesses the server and database and available adventures may be displayed. At 702 a user selects an adventure. At 703, the system may access the adventure data and associated templates and characters. At 704, the recipient name may be entered. At 705, the selected adventure is displayed to the user. At 706, the information for a designated third party may be entered. Embodiments of the present invention may allow a giver to designate a third party close (e.g., in proximity) to the recipient to coordinate the customization of information and/or the delivery of the mailers and gift. For example, a giver may be in an uncle in another state and coordinate the adventure by entering the email of the parent of the recipient so the parent can enter customization information for the recipient, receive a packaged delivery and deliver the individual mailings to the recipient, or enter the location of the gift, for example. At 707, the location of the gift may be entered. The location may be encoded and loaded into a printing control document as described in more detail below. At 708, character data associated with the adventure may be accessed. At 709, the character to be used in the adventure may be selected from a plurality of characters associated with the adventure. At 710, the giver information is entered (e.g., name, email). At 711, recipient specific data is entered (e.g., address, name, and customized data for the recipient such as likes or dislikes, favorite games or foods).

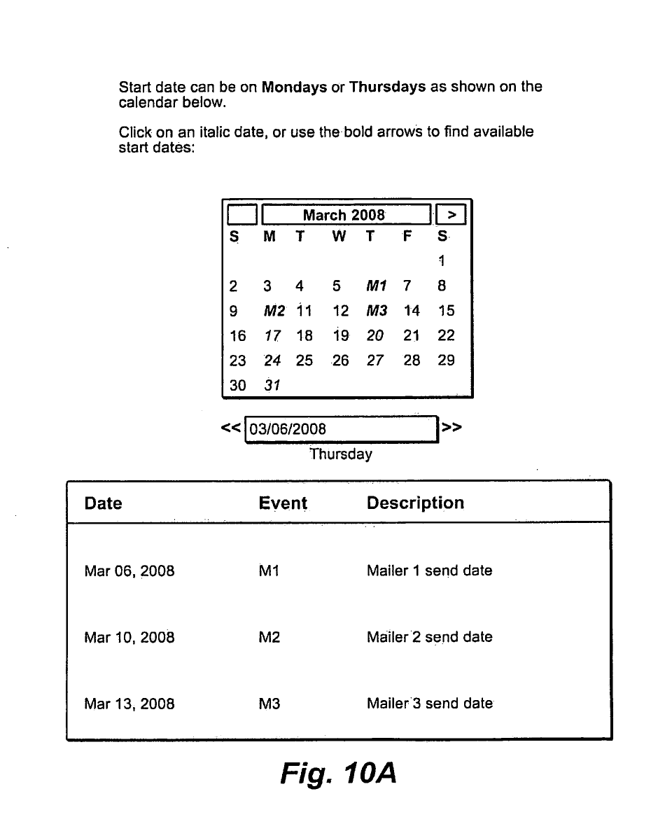

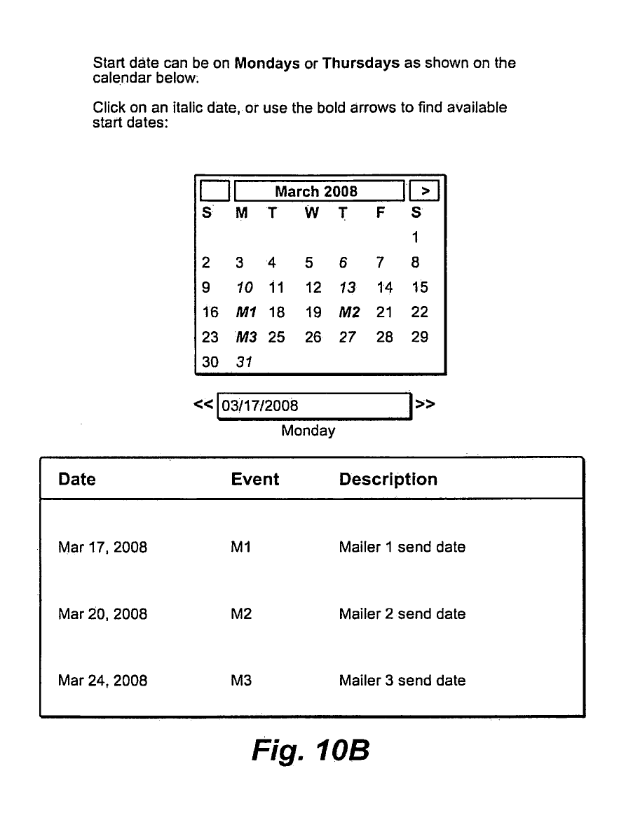

At 712 through 715 a user may schedule delivery of the mailers. For example, at 712 a calendar may be displayed with delivery frequency data provided based on available printing dates. FIG. 10A illustrates an example calendar according to one embodiment of the present invention. As illustrated in FIG. 10A, the start dates are limited to Mondays and Tuesdays. The calendar automatically listed the next occurring Thursday as the default date of the first mailing (M1), the next occurring Monday as the default date of the second mailing (M2), and the next occurring Thursday as the default date of the third (in this example final) mailing (M3). Additionally, a user may select any Monday or Thursday for the first mailing date and the system will automatically schedule the remaining mailers based on the number of mailers and the predetermined start dates and generated the control documents for printing and mailing by such start date. Therefore, all the subsequent Mondays and Thursdays are displayed differently (e.g., as a different color or font) to indicate that these are available start dates. As illustrated in FIG. 10A, the start date defaults to Mar. 6, 2008 for the first mailing. Accordingly, the subsequent mailings are set on the calendar and the dates, events, and descriptions are described below. In FIG. 10B, the start date has been changed (e.g., by a user) to Mar. 17, 2008, and the mailing dates for all the mailers have been automatically updated. It is to be understood that printing and mailing may occur on the same day or different days. In this example, the start dates are mailing dates, but the print control document may be generated and printing may occur a set amounts of times before the start date to ensure the document arrives in time to be printed, and the printing occurs in time to be mailed. Accordingly, the printer control document may specify the mailing date, and the printer control document may be generated an amount of time in advance of the mailing date to ensure printing and mailing occurs on the specified date.

Referring again to FIG. 7, the number of mailings associated with an adventure may accessed from the repository to schedule the delivery of the mailings. Additionally, the available dates (i.e., the dates on which mailings occur) may be accessed. The number of mailings may be used with the available start dates to generate a calendar to be displayed to a user. The calendar may automatically highlight the available start dates, and a user may select any available start date for the first mailing for the adventure, and the calendar will automatically, based on the number of mailings, highlight the mailing dates of the other mailings of the adventure on the available dates. For instance, at 712 the calendar is displayed as described above. At 713 the system receives the user's selected start date. At 714 the system updates the calendar display based on the delivery frequency (available start dates) and the user's selected start date. At 715, the delivery frequency data for the adventure are stored with the user's adventure data for use in generating the printer control document.

Once the start date has been specified, a giver may enter the recipient's address at 716. Based on the information for the specific adventure, a printer control document may be created for each start date, where each printer control document for each start date includes printing data for each adventure having that start date. At 717 a plurality of mail items comprising a plurality of different customized letters corresponding to the selected adventure and adventure specific graphics are generated and received by a recipient on a plurality of different days over a predefined time period (or in a single package if package delivery is selected).

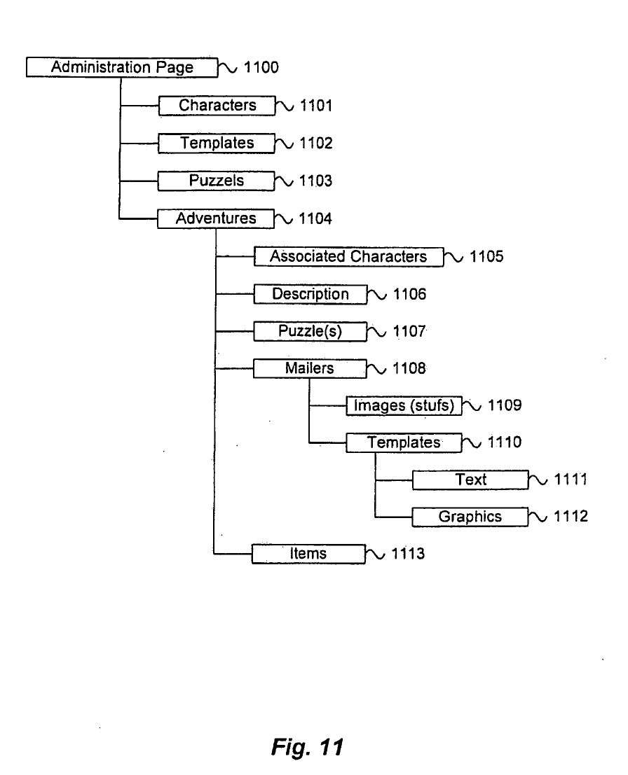

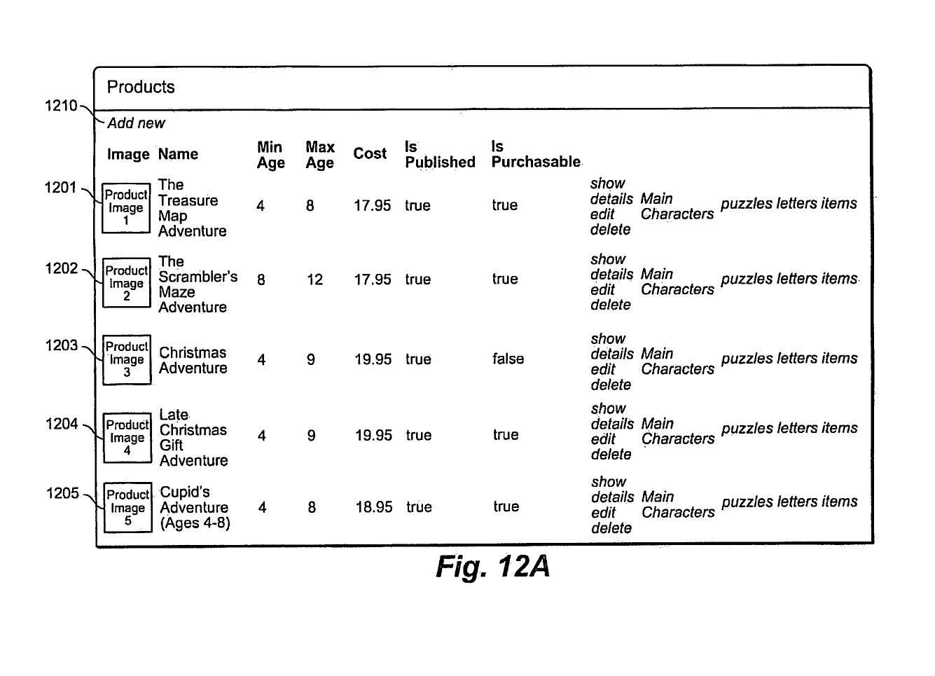

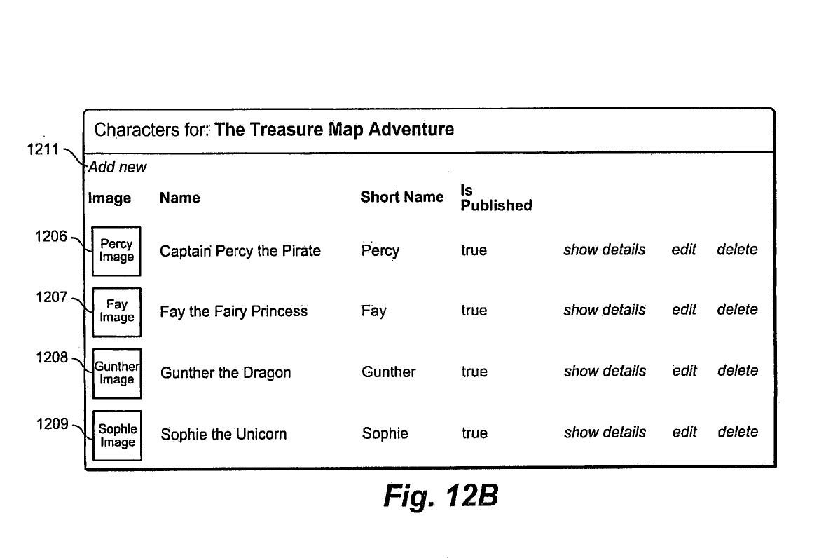

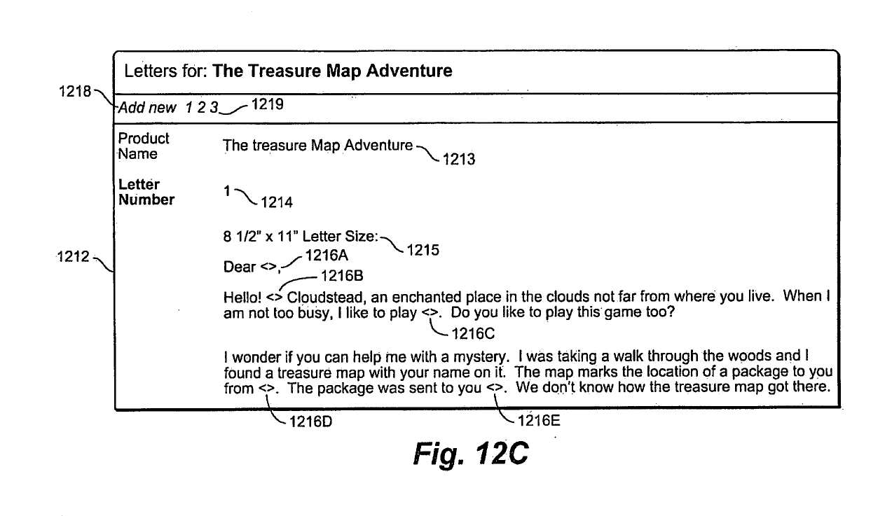

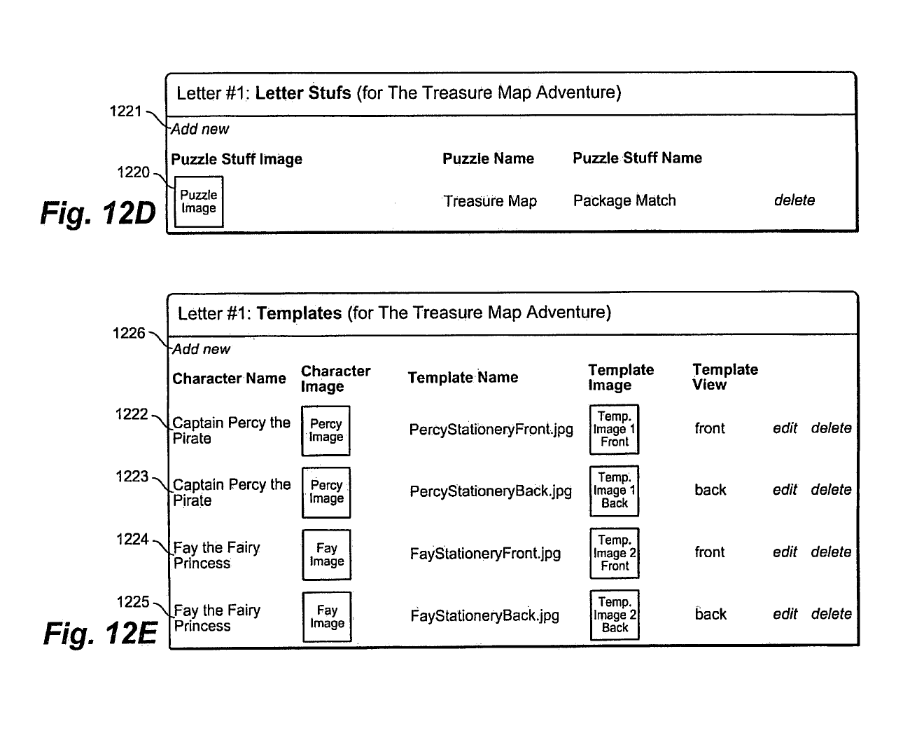

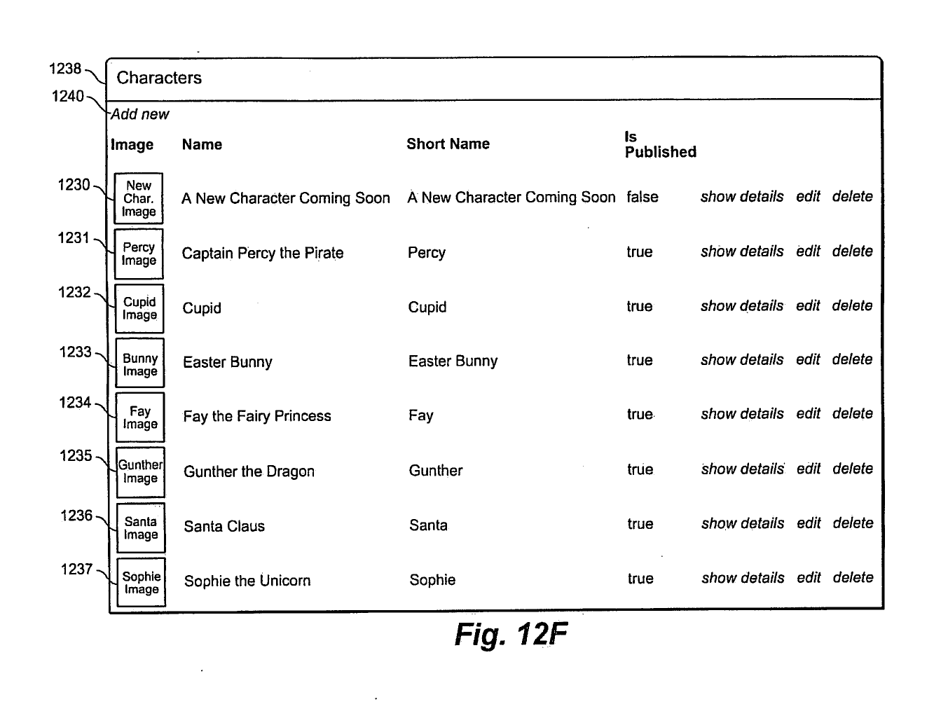

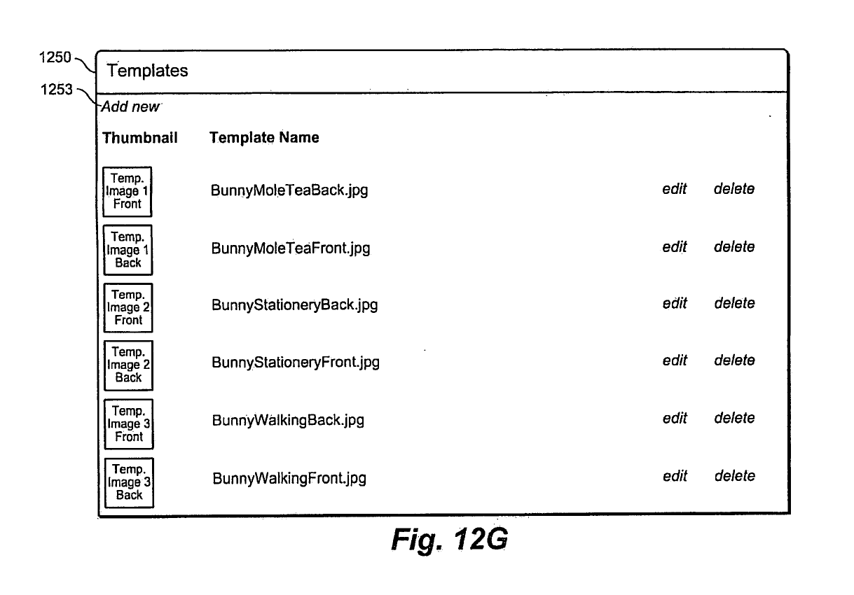

FIG. 11 is an example of an administration architecture according to one embodiment of the present invention. The administration architecture in FIG. 11 illustrates the componentized approach of the system that provides the advantage of flexible customization and expansion of activities. Features and advantages of the herein described architecture for implementing customizable activities include the ability to allow third parties to design and incorporated custom components to the system. For example, third parties can create and incorporate graphics, text templates, characters, complete activities or adventures, puzzles, or a variety of other items for use with the system. In FIG. 11, an administration page 1100 may include features for viewing and incorporating new components into the system. For instance, in this example administration page 1100 may include a link for working with characters 1101, text templates 1102, puzzles 1103, and adventures 1104. Adventures 1104 may include a listing of all the available adventure records stored in the system and may include a mechanism for adding adventures to the system. FIG. 12A illustrates an adventures (or products) page. FIG. 12A is a display of the some fields of adventure records stored in the system. Adventure records 1201-1205 include an image, name, minimum age intended for recipient, maximum age, cost, and fields for specifying whether or not the product is published (i.e., available for viewing on the website; some adventures with incomplete data may not be published, for example) or purchasable. Additional links may be included for obtaining additional information about the adventure, such as a detailed text description, an editing page, characters associated with each adventure, puzzles associated with each adventure, letters associated with each adventure, and items (e.g., puzzles) associated with each adventure. An “Add new” link may be included to allow third party developers to upload new adventures. For example, a third party user may click the “Add new” link and be taken to a page for entering or uploading any of the information for an adventure record, including an image, name, and a variety of other information about the adventure or activity. The “Main Characters” link may be used, for example, to show any character records associated with the adventure record and may be used to add or modify the character records associated with the adventure record. FIG. 12B illustrates the “Main Characters” page. Here, the character records associated with the Treasure Map Adventure are shown, which includes character records 1206-1209. Each record may include an image, name, and short name, for example. Additional links may be included to show details about the character record, edit the character record, or delete the character record.

Another “Add new” link 1211 allows additional character records to be associated with the particular adventure record. For instance, by clicking on “Add new” 1211, a user may select other character records to associate with the “Treasure Map Adventure” record 1201. Additionally, customized character text for use with a character in a particular adventure may also be stored so that different character records will associate different customized text with different adventures. In particular, customized text may be associated with a particular character record that is associated with a particular adventure record so that the use of that character in that adventure results in the customized text being incorporated into a fillable field of one or more template letters used with the adventure.

Furthermore, a user may view and associate text template letters with fillable fields with each adventure. The template letters may be stored as records in a database. For example, FIG. 12C illustrates a template letter record 1212 associated with the Treasure Map Adventure. The template letter record 1212 includes a name 1213, letter number 1214 to indicate which mailing the letter is to be sent with, a letter size 1215, and text with fillable fields 1216A-D for inserting customized information about a recipient or associated character, or both. Each template letter number for different mailings may be accessed through links 1219. In this example, the first fillable field 1216A of template letter 1 may be filled in with customized information about the recipient obtained from the giver (e.g., Dear < >, where < > is filled in with the name of the recipient). However, the second fillable field 1216B may be filled in with customized information about an associated character record selected for this adventure (e.g., < > may be filled in with “My name is Capt. Percy. My ship is in”). New letters may be created and incorporated into the system through the “Add new” link 1218. Template letter records may include letter name, letter number, letter size, text with fields, letter interval, and may include a return address specific to the template letter so that recipients of the letter will see a specific return address corresponding to the character (e.g., a return address of “The North Pole” for a letter from Santa Claus).

In this example, puzzles may be associated with the adventure record through the puzzles line in FIG. 12A. Accordingly, all the puzzles associated with the adventure record are available for incorporation into a mailing. Puzzles are stored as images in the system and associated with adventures. Particular puzzles may further be associated with each template letter so that a puzzle image and template letter are provided in the same print control document for printing and mailing. For instance, each template letter having a different letter number may have a link to the puzzle image or other “letter stuffs” to be printed mailed with the letter. These letter “stuffs” (i.e., stuffed in with the letter) to be mailed are illustrated in FIG. 12D, which shows puzzle record 1222 associated with letter number 1 of the Treasure Map Adventure 1201. The puzzle record may include an image of the puzzle and puzzle name, for example. The “Add new” link 1221 allows a user to associate an available puzzle record already associated with this adventure record with this template letter.

FIG. 12E illustrates graphic template images associated with template letters according to one embodiment of the present invention. Template images may be printed on the front and back of the final printed letter in addition to the filled in customized template text. In this example, each character associated with an adventure has two corresponding template images—a front template image for printing on the front of the letter and a back template image for printing on the back of the letter. Character records for characters 1222-1225 that are associated with the adventure record are displayed to the user with the character name, character image, template image name, and the template image, for example. New template images may be associated with character records and associated with the template letter by accessing the “Add new” link 1226.

In addition to creating new adventure records for new adventures on the system, third parties may further enhance existing adventures by creating new characters. FIG. 12F illustrates that character records for all the characters in the system may be accessed and modified and new characters uploaded and integrated. Page 1238 may display character records 1230-1237 independent of adventures. These are all the character records available in the system for use in an adventure (e.g., for association with an adventure record). Each character record includes an associated image, name (e.g., for one use in a fillable field), and short name (e.g., for another use in a fillable field). A user may also upload new characters to the system by selecting the “Add new” link 1240 and incorporating character data into a new character record for use in an adventure. Similarly, graphic images may be uploaded and integrated into the system for use with different characters or adventures. FIG. 12G illustrates different graphic images which may be associated with particular template letters or puzzle images for mailings. New images may be uploaded by selecting the “Add new” link 1253.

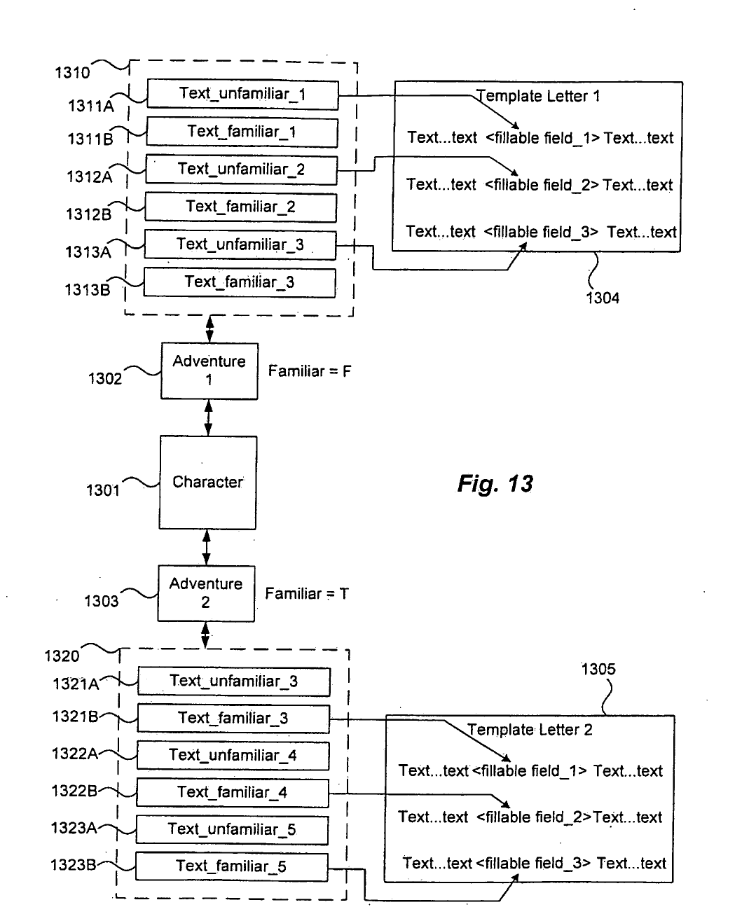

FIG. 13 is an example of records mapped to fillable fields in a template letter according to one embodiment of the present invention. As mentioned above, different customized text may be used to fill in fields of template letters. For example, different text may be selected for use based on the adventure a character is in (e.g., an association between an adventure record and a character record). As another example, different text may be selected for use based on whether or not a particular recipient is familiar with a character (i.e., whether or not a particular recipient has received a letter from a particular character in the past). FIG. 13 illustrates both selection of text based on the adventure a character is in and selection of text based on familiarity. In FIG. 13, a character record 1301 is associated with two different adventure records 1302 (“Adventure 1”) and 1303 (“Adventure 2”). Embodiments of the present invention may store first text 1310 for filling in one or more fields of one template letter 1304 when character record 1301 is associated with adventure record 1302 and store second text 1320 for filling in one or more other fields of a another template letter 1305 when the character record 1301 is associated with a second adventure record 1303. Accordingly, the same character may be used to fill in different fields of different template letters and/or say different things to the recipient based on the adventure the character is in.

Here, adventure 1302 may have a corresponding template letter 1304, which may include multiple fillable fields. The fillable fields may be filled with text based on the character used in this adventure. For example, since character 1301 is associated with adventure 1302, text items 1310 may be used to fill in the fields of template letter 1304. Similarly, adventure 1303 may have a corresponding template letter 1305, which may include multiple fillable fields. For template letter 1305, character 1301 is associated with adventure 1303, so different text items 1320 may be used to fill the fields of that template letter for this character. Of course, different characters may have different associated text for a given adventure and associated template letter as well, which was mentioned above.

FIG. 13 also illustrates the use of familiarity. In one example embodiment, the system may store a designation that a character is familiar to a recipient. For example, if a new recipient is added to the system for receiving an adventure with a specific character, the system may designate that the character is not familiar to the recipient (e.g., familiar=False). However, after a mailing is sent to the recipient for an adventure with a particular associated character (or after a giver has ordered an adventure with a particular character for a recipient), the system may designate that the character is familiar to the recipient (e.g., familiar=True). As an example, the system may store the name of each recipient and associate the character record that the recipient has interacted with. If a new adventure with a specified character is sent to a recipient, the system may search for the recipient and determine if the same recipient has received any adventure with the same character in the past. If the same recipient and associated character are found, then the system may set familiar to TRUE, and if not, then familiar is set to FALSE (e.g., for a new recipient or a past recipient who has not been associated with the same character in the past). As illustrated in FIG. 13, the system may store text 1311A-1313A for use in template letter 1304 if familiar=F, and the system may store text 1311B-1313B for use in template letter 1304 if familiar=T. Each of the text elements may be stored as fields of a record (e.g., elements of a row in a table), for example, in a database. Accordingly, the system may map text from a first field of a record to a fillable field of a text template if the character is designated as familiar, and map text from a second field of a record to the fillable field of the text template if the character is designated as not familiar. Here, the use of character 1301 in adventure 1302 for the particular recipient causes familiar to be set to false (Familiar=F). Accordingly, text element 1311A is used to fill a first fillable field in template letter 1304 (<fillable field_1>), text element 1312A is used to fill a second fillable field in template letter 1304 (<fillable field_2>), and text element 1313A is used to fill a first fillable field in template letter 1304 (<fillable field_3>). However, the use of character 1301 in adventure 1303 for the particular recipient (e.g., the same or different recipient) causes familiar to be set to true (Familiar=T). Accordingly, text element 1321B is used to fill a first fillable field in template letter 1305 (<fillable field_1>), text element 1322B is used to fill a second fillable field in template letter 1305 (<fillable field_2>), and text element 1323B is used to fill a first fillable field in template letter 1305 (<fillable field_3>). Accordingly, each character's interaction with a user may be customized based on the adventure the character is in and the familiarity of the recipient with the character.

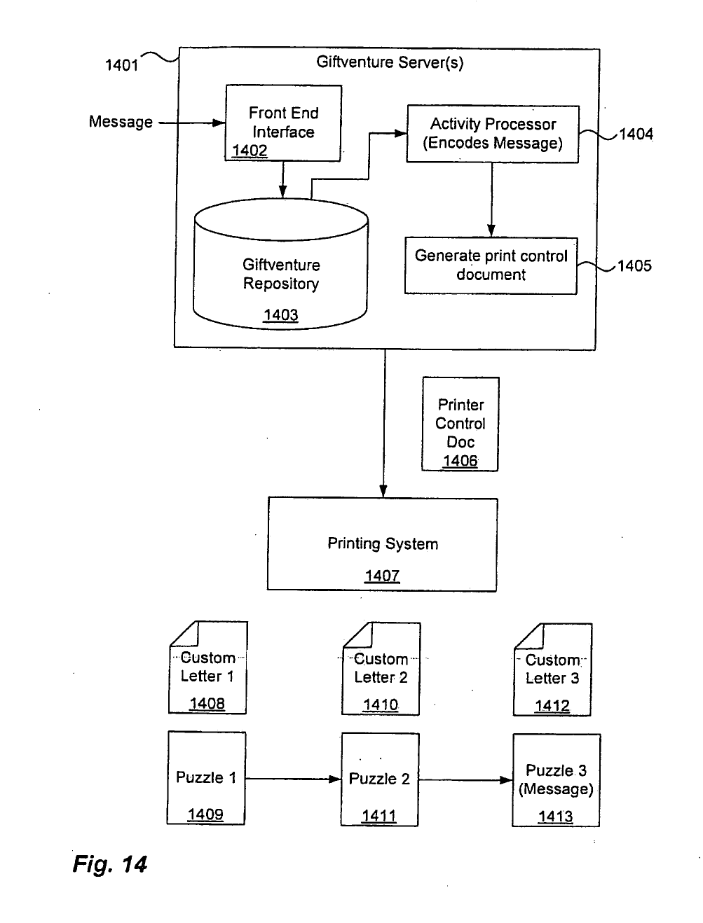

FIG. 14 illustrates entering a message according to another embodiment of the present invention. In some embodiments, a user may enter messages to be sent to recipients as part of an activity. A variety of messages may be used for a variety of activities. For example, messages may include locations, hints, personal messages, or messages that correspond to the furtherance of the particular activity (e.g., to solve this mystery, go to <<address>>). In this example, the message is received by front end interface 1402 of server 1401. The message may be stored in repository 1403. Features and advantages of the present invention may further include receiving the message and encoding the message (e.g., for printing). A recipient may receive a mailer with the encoded message and decode the message (e.g., to discover the location of a gift). While the examples described herein refer to a hidden gift, encoded locations may be used for a variety of other purposes (e.g., rendezvous, vacation plans, or as part of a treasure hunt to name just a few). Activity processor 1404 may receive the message and perform the encoding. A variety of encoding techniques may be used depending on the type of mailing being generated, for example. A printer control document 1406 may then be generated by server at 1405 with the encoded message and other printer control information (e.g., recipient's name and address). In one embodiment, the message may be encoded into a single field of the printer control document, and the encoded field is printed on a mailer item for decoding by a recipient. In another embodiment, the message may be encoded into a plurality of fields of the printer control document, and the fields are printed on one or more mailer items for decoding by a recipient. Example encodings are presented below for different printed puzzles. A printing system 1407 receives the printer control document and generates the mailers. In one embodiment, each adventure includes multiple mailers. For example, an adventure with three mailers may cause printing system 1407 to receive a printer control document 1406 on a first day with a record for printing a first mailer (the printer control document received on the first day may also include multiple other records for other adventure mailers to be printed on that day). The first mailer may include a customized letter 1408 and a puzzle 1409. Similarly, the second mailer may include a second customized letter 1410 and a second puzzle 1411. Finally, the third mailer may include a third customized letter 1412 and a third puzzle 1413. Solving the first puzzle may result in information required for solving the second puzzle, and solving the second puzzle may include information required for decoding the message in the third puzzle, for example. Each letter may also include information for solving the corresponding puzzle or other puzzles, for example. Any one or more mailings may include a message used in the activity.

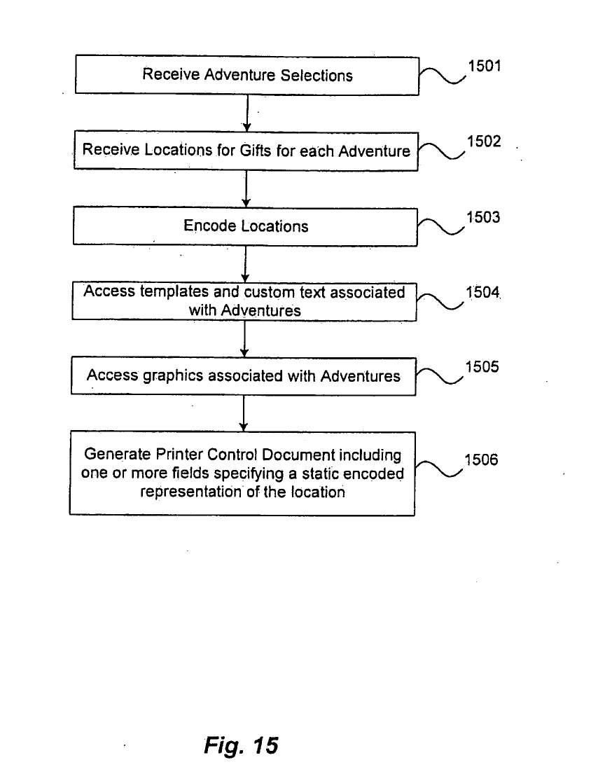

FIG. 15 illustrates a method including encoding a message according to another embodiment of the present invention. At 1501, a server may receive selections of adventures from different givers for different recipients. The adventure records for the selected adventures may be accessed according to the selection. In this example, the message is a location of a gift as mentioned above. Accordingly, at 1502, locations for gifts may be received for each adventure, stored in a repository, and associated with each adventure record. At 1503, the location is encoded. In one embodiment, the adventure record may have one or more associated puzzles, and the location encoding is based on a particular puzzle associated with the adventure record. For example, an adventure associated with a treasure map may have one encoding for printing the map, an adventure associated with a cipher may have a second encoding, and an adventure associated with a hidden word puzzle may have yet another encoding. At 1504, template letters associated with the adventure record and the customized text from a user (e.g., the giver or a third party coordinator) or text associated with the character record selected for the adventure, or both, may be accessed. At 1505 graphics associated with the adventure record and associated character and template letter are accessed. At 1506, a printer control document is generated. The printer control document includes one or more fields specifying an encoded representation of the location, and may further include the location itself.

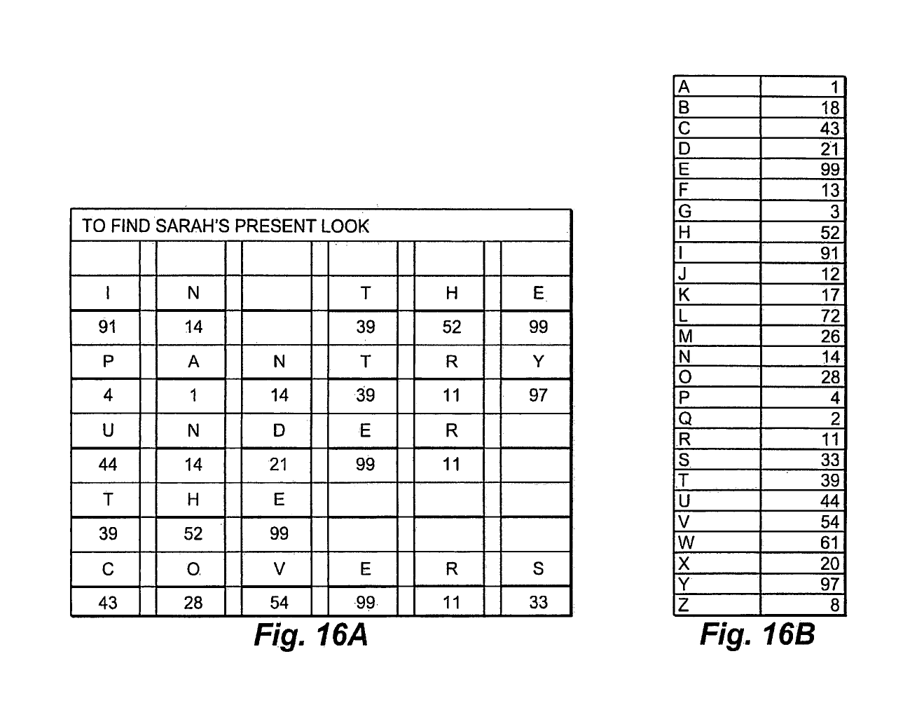

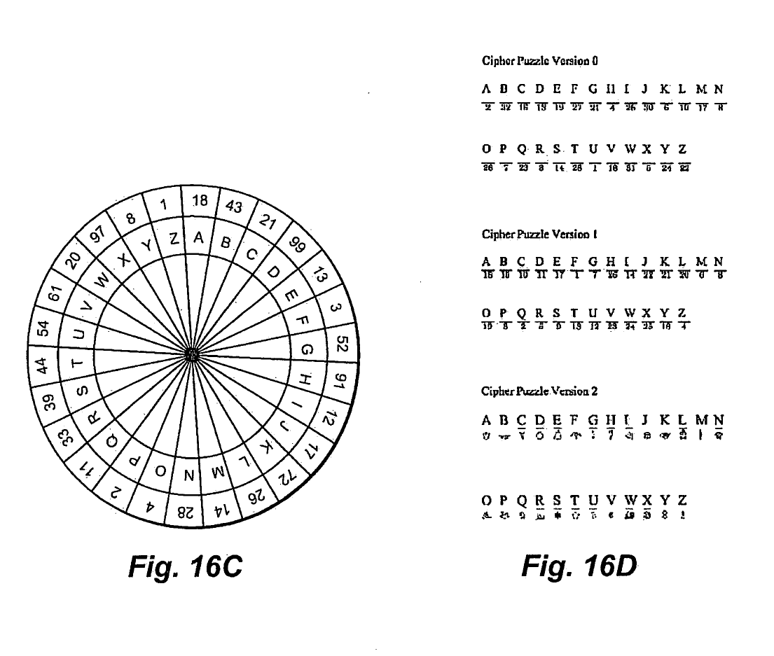

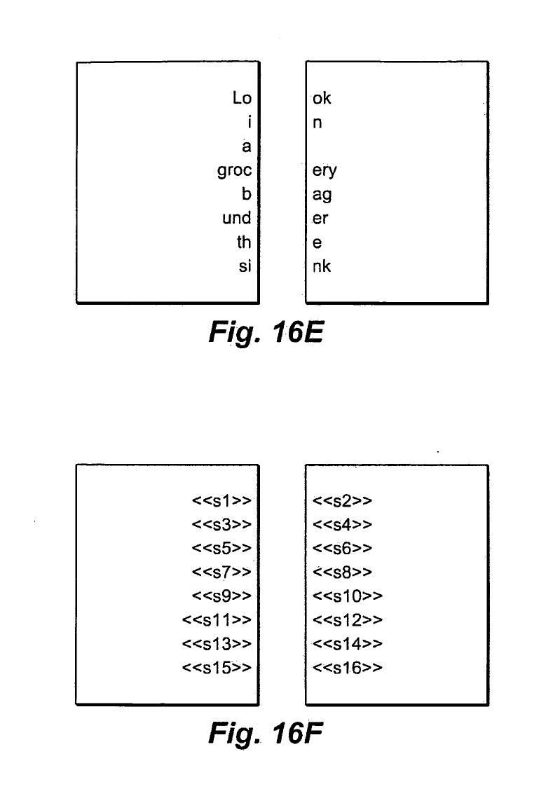

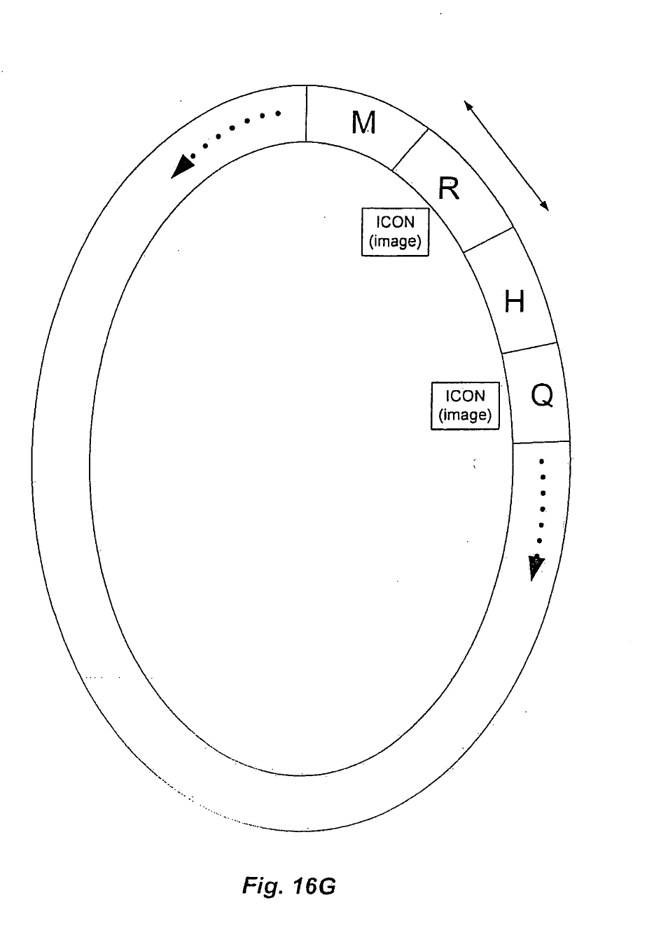

FIGS. 16A-G are examples of encoded location messages for different puzzles according to different embodiments of the present invention. FIGS. 16A-D are examples of a cipher puzzle with an encoded location. FIG. 16A illustrates a basic substitution cipher. The recipient initially receives blank spaces (no letters in FIG. 16A) with numbers under the lines, and the characters are to be filled in by the recipient. The location is encoded as a series of numbers. A table in FIG. 16B may define the mapping of numbers to letters (A=1, B-18, etc. . . . ). The mapping between numbers and letters may be changed for different cipher puzzles used with different adventures. For example, a first customer may have A=1, B=18, C=43, and another customer may have A=18, B=43, C=21. The mapping will change the encoding of the location, and therefore, the numbers printed on the cipher. The table can be changed to implement the mapping. Additionally, symbols or pictures can be used instead of numbers. In any event, the table used for a particular customer must be saved on a per customer order basis. Accordingly, an encoding algorithm may be associated with each adventure record for each recipient, for example. FIG. 16C illustrates a cipher wheel with a first inner wheel of alphabetical characters that is circumferentially moveable relative to a second outer wheel of numbers. The inner and outer wheels may be separate images to be printed and aligned by the recipient. The wheel may be used to decode the numbers from FIG. 16A and determine the encoded location. A “key” may be displayed in the customer account page or revealed to a user using a previous puzzle (e.g., A=1, which may be used to align the wheel to read off the mapping for the other numbers). In some embodiments, multiple keys per puzzle may be used. To encode the location as numbers, one embodiment may perform a font mapping. For example, the encoding may be a mapping of fonts from text describing the location (e.g., under the bed) to an encoded representation of the location. For instance, the location may be included in the printer control document. Additionally, a field in the printer control document may specify a font to use when printing the location. The font specification here represents the encoding of the location. Additionally, the printer control document may include a “puzzle type”. The puzzle type specifies the type of puzzle being printed (e.g., a cipher) so that the printing system interprets the mapping properly. However, rather than printing as alphabetical characters, the font prints numbers, symbols, or other visuals. In FIG. 16A, the font for “I” is mapped to “91”. The cipher key may also be included in the printer control document for printing (e.g., in a letter). FIG. 16D illustrates other mappings for other alphabetical characters to different numbers and symbols. The symbols may be any custom designed fonts, for example.

Hidden letters in a sequence illustrates yet another location encoding scheme. For example, the location “in closet” may be hidden in every third letter as follows:

### A D [I] F E [N] K I [C] G R [L] L 0 [O] S E [S] S E [E] V T [T] Y Y

The brackets [ ] are included to highlight the encoded location. To implement this encoding, the system may take a location text sequence, take out the spaces in between words, add N number of random letters in between each letter, where N is configured during puzzle set up, optionally, but suggested, auto check for foul words not to be spelled to children, and optionally add in N number of spaces between letters. The result is passed to a designated field in printer control document (e.g., Printer API->puzzle_type=“dragons_lair” and location_modified_1=<alphabetical sequence>).

FIGS. 16E-F illustrate another encoding where the words in a location are broken up on different printed items. For example, FIG. 16E illustrates the location “Look in a grocery bag under the sink”, where the words have been divided up across two pages. In this example, a child may fold or match two pieces of paper up to discover the sentence and decode the location. This may be implemented by setting the printer API->puzzle_type=“break_up_words”. Each word in the text describing the location “Look in a grocery bag under the sink” is broken into two parts by the system, where single letters and words with odd numbers of letters may have an extra letter on the right. Each part is stored in a different field sent to the printer API. For instance, the Printer API may include fields <<s1>> to <<s100>>. The printed document may be laid out as illustrated in FIG. 16F, where <<s1>>=Lo, <<s2>>=ok, etc. . . . . The <<sN>> sequence will appear in the printer API with fields set by the encoding component of the server system.

FIG. 16G illustrates a map encoding scheme for the location. In this example, letters of the alphabet are printed on a map such as a path as shown. A user may determine the encoded location by starting on a specified letter of the map and moving between letters according to instructions. The instructions may be encoded to represent the location. As an example, a child has to use the spaces on a treasure map to find his sentence that reveals the location. Each space has a letter and may have a location/icon next to it. Each time the child goes to a “space” he/she writes down a letter on a piece of paper. Once she/he completes the trail, the location is decoded. For example, the following instructions may be included in a printer control document for finding the location:
Instructions
Start Go to The Library
Move 4 Spaces backward
Stay there and write the letter again
Move 2 Spaces forward
Rest day—leave a blank spot
Go to Ice Cream Shop
Move 7 Spaces backward
Rest day—leave a blank spot
Go to The Trident
Move 7 Spaces backward
Move 4 Spaces backward
Rest day—leave a blank spot
Go to Delos Island
Move 8 Spaces forward
Move 2 Spaces forward
Move 6 Spaces forward
Move 5 Spaces backward
Move 3 Spaces backward
Rest day—leave a blank spot
Go to Black Adder's Hideout
Move 10 Spaces forward
Rest day—leave a blank spot
Go to The Trident
Move 7 Spaces backward
Move 4 Spaces backward
Rest day—leave a blank spot
Go to Gunther's Cave
Move 12 Spaces backward
Move 8 Spaces backward
Move 11 Spaces backward
Move 3 Spaces backward
Move 11 Spaces backward
Move 11 Spaces backward
Move 3 Spaces backward
   The answer is revealed as “Look in a desk drawer by the computer”.

One technical solution to this encoding scheme is to create a table with N spaces in order-N number of spaces (e.g., 26 to start). Each space has a [name] (e.g., “Library”) which is entered at puzzle set up. Each space has a [letter] (e.g., “L”) which is entered at puzzle set up. For a location, “Look in my pocket on the right”, the encoding algorithm looks at each letter, and if it is the start of a word, it generates: “Go to [name]”, with “Go to” is specified at puzzle set up and [name] is determined by table look up. For the 2nd letter of a word, the system generates Go X spaces [forward/backwards], where X is the shortest distance in terms of number of spaces between the current and previous letter, and “forwards” or “backwards” is determined by the shortest path to get to the next letter. These encoding instructions for the location may then be exported to the printer control document. For example, the printer API field “puzzle_type”=“treasure_map”, and each sentence (one per letter) is put in one field of the print control document. The printer API, for example, may have a series of fields going from 1-N, where N is the total number of characters possible in a location sentence. The following is a listing of printer control document fields for encoding a location in a printed map.

<<s1>> Go to The Library
<<s2>> Move 4 Spaces backward
<<s3>> Stay there and write the letter again
<<s4>> Move 2 Spaces forward
<<s5>> Rest day—leave a blank spot
<<s6>> Go to Ice Cream Shop
<<s7>> Move 7 Spaces backward
<<s8>> Rest day—leave a blank spot
<<s9>> Go to The Trident
<<s10>> Move 7 Spaces backward

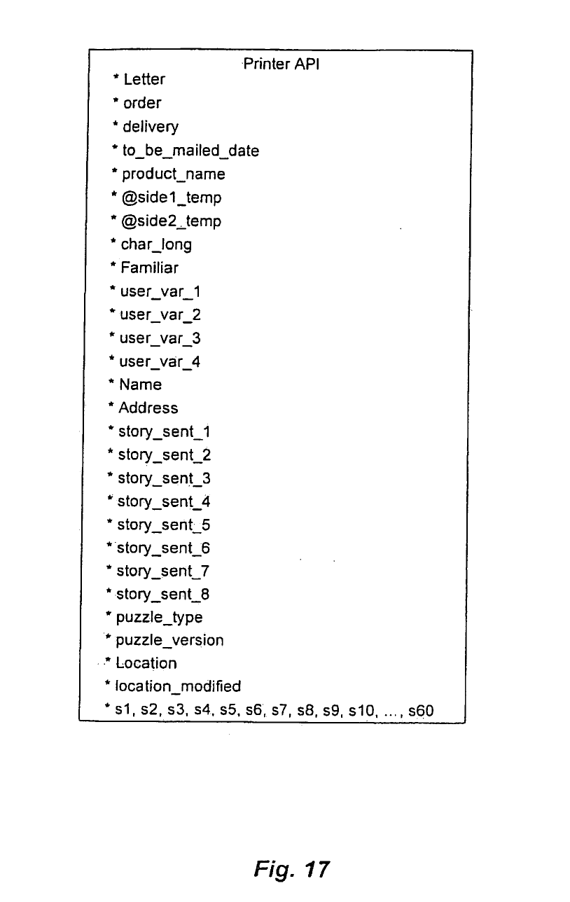

FIG. 17 illustrates an example schema for a printer control document according to one embodiment of the present invention. The schema includes a “Letter” field that indicates which letter in the series the current record is for. Letter 1 of N letters, etc. There will typically be one record per letter in a given Order. So, if order #2343 is a product that has 3 letters, there will be three records, one with letter 1, letter 2, and letter 3. The “Order” field is the unique identifier for an order, such as #2343. Note there are can be several letters per order, which is why there are multiple records with the same order#. The “delivery” field may be used to indicate to the printing system whether the mailers are sequential delivery or packaged delivery. If the delivery field specifies package delivery, an additional package is created, an insert letter is printed to the gift coordinator, and the name and address for the mailer is the name and address of the coordinator. The “to be_mailed_date” specifies the start date, or the date that a particular letter is scheduled to be mailed. The “product_name” is the name of the product, such as “Treasure Map.” The “@side1_temp” indicates the image that is to be used for SIDE 1 of a letter. This image indicator is based on a number of factors including character choice, letter # in a series, etc. The “@side2_temp” is similar, but for SIDE 2 of the same letter. The “char long” is a text string of the character's name that was chosen for the product. The “Familiar” field indicates whether the recipient has received an adventure product from the character chosen previously. If yes, different “story_sent_N” sentences are included below. The inclusion of the “Familiar” field in the printer API is optional for reference in case a manual quality check is required on a product. The “user_var_{—}1”, “user_var_{—}2”, “user_var_{—}3”, and “user_var_{—}4” fields are inputs that the purchaser (e.g., giver) enters when they order, such as “Enter the child's favorite game:”. These are customized text fields associated with the adventure record about the recipient. The “Name” and “Address” fields are the name and address of the recipient. The “story_sent_{—}1”, “story_sent_{—}2”, “story_sent_{—}3”, “story_sent_{—}4”, “story_sent_{—}5”, “story_sent_{—}6”, “story_sent_{—}7”, and “story_sent_{—}8” fields are dynamic story sentences in an adventure that change depending on character choice and familiarity of the character. For example, in the sentence “The people were surprised to see a [story_sent_{—}3] in the super market,” [story_sent 3] can change depending if the character is a “dragon,” “pirate,” or “fairy princess.” A dragon character record may have a “familiar story_sent_{—}3” field and an “unfamiliar_story_sent_{—}3” field that may be selectively loaded into the printer control document for generating a custom letter based a familiarity of the recipient with the character. The “puzzle_type” field indicates the type of puzzle that is being used in a product. The “puzzle_version” field indicates the version # of the puzzle, in case of different version options, such as font cipher solutions. The “Location” field is the text string for the location (e.g., where the present is hidden as entered by the giver or third party). The “location_modified” is the representation of the “location” text string modified by encoding processes as determined by the “puzzle_types”. Some puzzle types will manipulate the data and render the result in this field. The fields “s1, s2, s3, s4, s5, s6, s7, s8, s9, s10, . . . s60” are the representations of the encoded “location” text string modified by encoding processes as determined by the “puzzle_types”. Some puzzle types will manipulate the data and render the result in these fields.

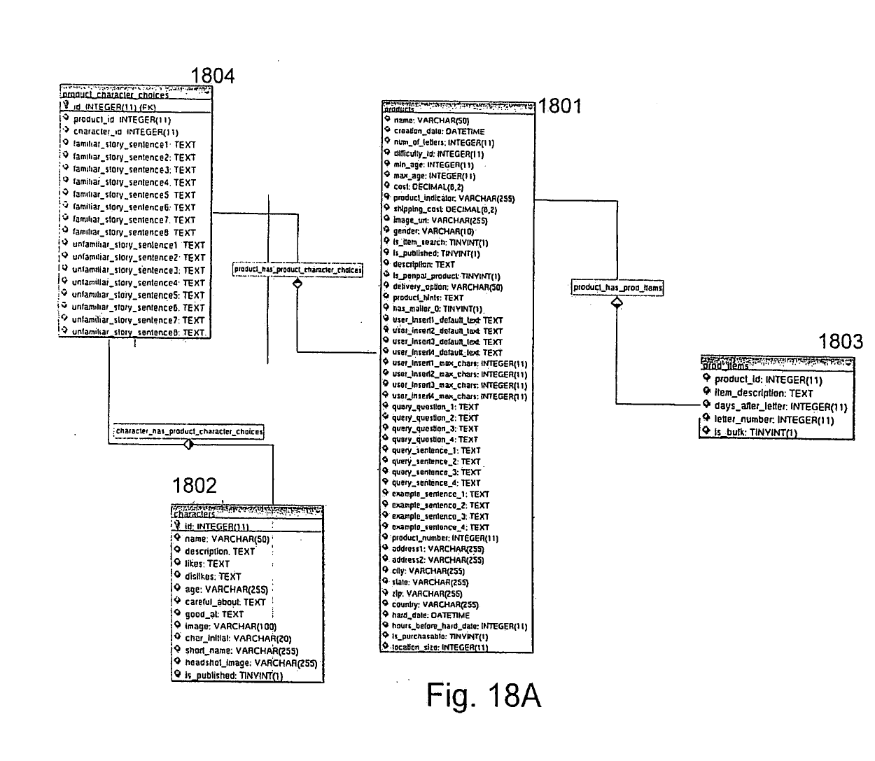

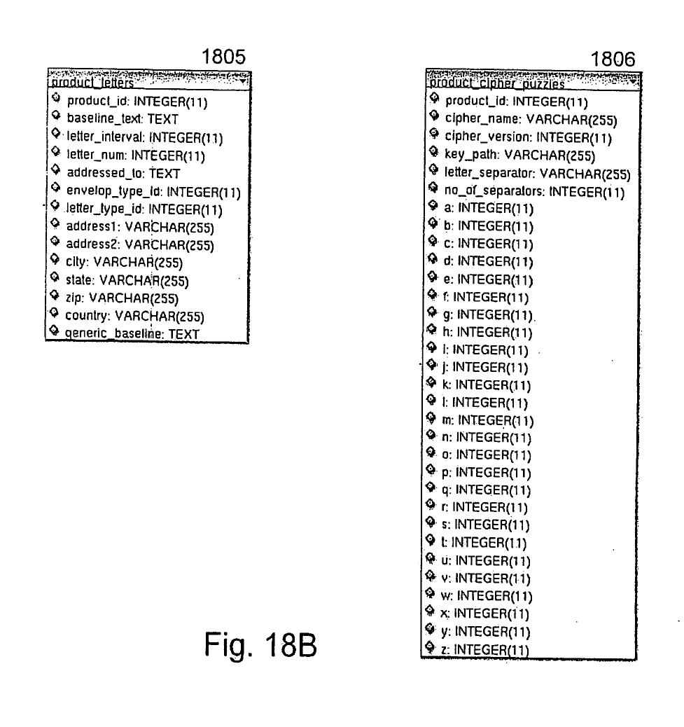

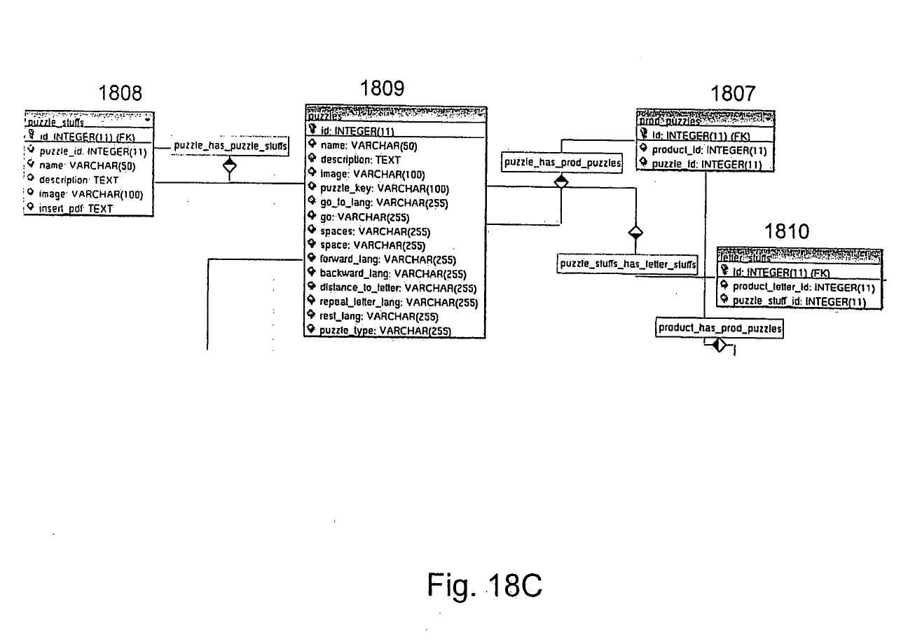

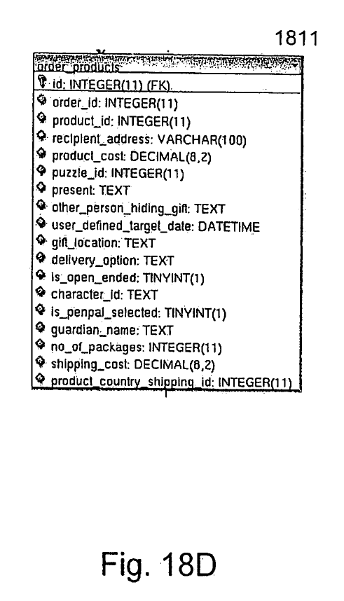

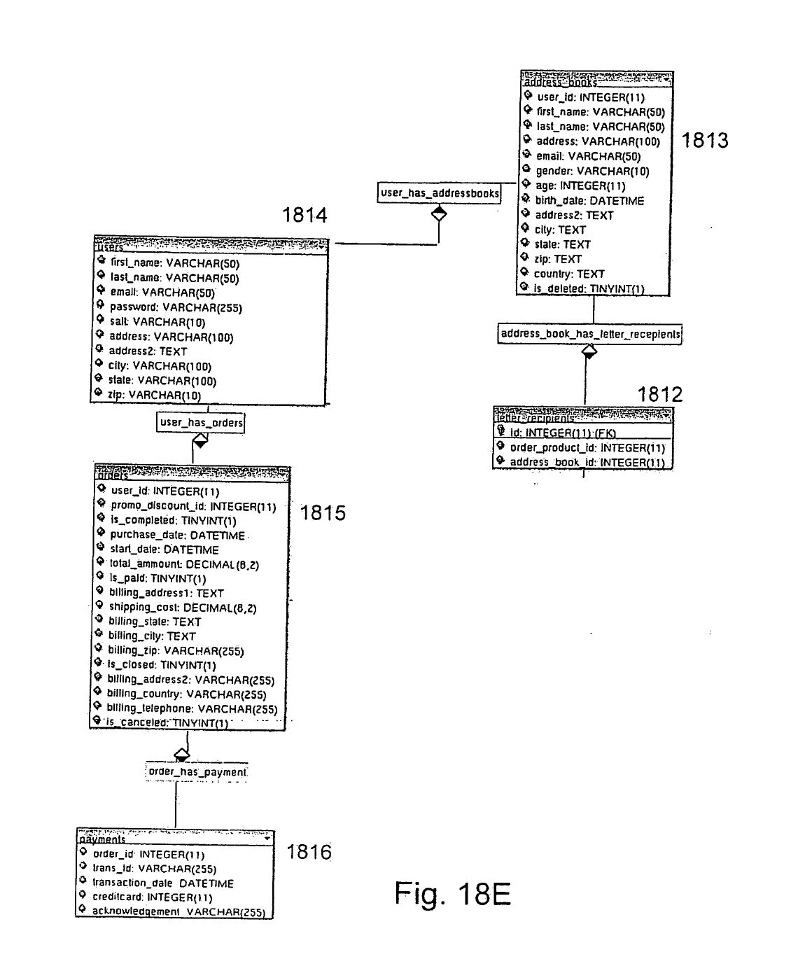

FIGS. 18A-E illustrates an example schema for a repository according to one embodiment of the present invention. According to this example implementation, a database may include a products table 1801, a characters table 1802, a product items table 1803, and a product character choices table 1804 as shown in FIG. 18A. Products table 1801 stores records for activities (e.g., adventures). Each adventure may include the following information in the adventure record: an id to serve as a unique identifier for each adventure, the name of the adventure, a product indicator that serves as a single letter representation printed on different adventure materials to indicate the product type, a “creation_date” when the adventure was created, the number of letters to be included in a product which can vary on a per product basis, the difficulty ID to allow difficulty tags for each product, entries for minimum and maximum recommended recipient ages, the product and shipping cost, gender tags to indicate gender preference in content if any, envelope return address to allow different adventures to come from different locations, description of the adventure to appear on the user-facing web interface, item search and published toggles to allow for product to placed in directories and to be appear on the web site, an URL pointing to (referencing) the image where the product image is stored for web-site display, product hints to store text to be displayed on the web site to help consumers decide if they want to purchase, and the different delivery options available for the product. There is also a series of fields to allow for a specialized series of questions to appear to query for personalized information about the recipient to personalize the overall experience. They include: query questions that ask for an input (e.g., “Enter a game the child likes to play”), user insert default text records for a default entry in case the user decides to skip entering the question (e.g., “Go fish”), query sentences that provide a fill-in-the-blank example sentence for the user to fill in to insure the syntax of the answer fits grammatically into the structure of the story in the adventure (e.g., “I like to play ______”), and max character records that are integers set per input to limit the input from the end user to insure the response will fit into the allotted spaces in the templates used in production. Finally, address fields are included to have different return addresses for each adventure, “hard_date” and “hours_before_hard_date” allow for an adventure to have a designated shipping date rather than a user-configured shipping date, “is_purchasable” allows for items to be displayed on the web site but not purchased (as might be appropriate for out-of-season adventures), and “location_size” stores the maximum number of characters the location variable might hold (this is important because different puzzle types may have different limits on the number of characters that can be supported in each template and this variable is used to force that restriction at the user entry point).

Character table 1802 stores character records. Each character may have the following information in the character record: an id to serve as a unique identifier for each character record, the name of a character, a URL pointing to an image of the character, and the character description and personal information, such as likes, dislikes, age, things the character is careful about and good at, birthday, etc.

Product items table 1803 (“prod items”) may be used in some implementations to store items (e.g., to do lists) for each adventure. The items may be sent to the giver or third party coordinator via email as reminders (e.g., “The first mailer was sent today so remember to buy a gift by May 10.”). Each record in table 1803 may have the following fields: an id to indicate the unique identifier for the record, an id associating the item with a particular product, a description of the item (e.g., “Make sure you have hidden your gift.”), a letter number value and days after letter value anchor the date of the item to a number of days after (or before) a scheduled letter date (e.g., the 2 days after the second letter mailing date), and whether the item is valid for bulk and other delivery types available for the product.

Product character choices table 1804 (“product_character_choices”) may be used in some implementations to alternative familiar and unfamiliar text for use with characters in adventures as described above. Each record in table 1804 may have the following fields: an id to identify each unique character choice per product, an id to associate the choice with the corresponding product, an id to associate the choice with the baseline character entered into the characters table, and a number of familiar and unfamiliar story sentences, which get dynamically inserted into the baseline text of a story at production depending on whether the character is determined to be familiar or unfamiliar to a recipient.

FIG. 18B illustrates a product letters table 1805, which may be linked with products table 1801. The records in table 1805 may include fields with text for use with template letters described above. Each record in table 1805 may have the following fields: an id and “product_id” to have a unique identifier to indicate each letter in a series for each product, the “baseline_text” and “generic_baseline” are two sets of letter text (one plain text and one designed to display user input variables inserted into the text) each used to display the letter contents on the user-facing side of the web site, letter interval is an integer representing the number of days the scheduler should wait before sending this letter from the previous letter sent (e.g., if a product has one letter to be mailed every four days in a series of letters, the letter interval would be “4” for four days), letter number indicates the position a letter is in a products series (e.g., letter two of three letters in a product), a return address (address1, address2, city, state, zip, country) to indicate the return address to be printed on the envelop for the specific letter, and an “address_to” field that indicates whether the letter should be mailed to the recipient or to the sender. For example, a particular letter in a series may be designated to be sent to the sender, rather than the recipient, in the case that it is a prop that the sender will use the enhance the experience of the recipient. One example would be an Easter egg or a Christmas tree ornament with a puzzle clue printed on its face that is sent to the sender to be placed for the recipient to find as part of the adventure).

A puzzle is created in the system and resides in the puzzles table 1809. For each puzzle, puzzle stuffs (or inserts that go in each letter) are created in puzzle stuffs table 1808. When a product is created in table 1801, a puzzle is associated with that product in the product puzzles table 1810. When each letter of a product is created in 1805, the puzzles stuffs defined in puzzle stuffs table 1808 are automatically associated with letter stuffs table 1807 thereby defining what is to be included with each letter.

Each record in table 1807 may have the following fields: an id to serve as a unique identifier for each record, and a “puzzle_id” to show which puzzle is to be linked to a product specified by the “product_id.” Each record in table 1808 may have the following fields: an id to serve as a unique identifier for each record, a “puzzle_id” to link the record to a puzzle record, a “name” and “description” of the puzzle for display on the user-facing web site, an “image” link to indicate the location of the image for display on the user-facing web site, and an “insert_pdf” to allow for PDF versions of some of the puzzle stuffs to be accessible to be downloaded from the user-facing web site in case the user loses a part of their mailings. Each record in table 1809 may have the following fields: an id to serve as a unique identifier for each record, a “name” and “description” of the puzzle for display on the user-facing web site, an “image” link to indicate the location of the image for display on the user-facing web site, “puzzle_key” is the key required to solve certain types of puzzles, and “puzzle_type” indicates the classification of the puzzle in question. “go_to_lang”, “go”, “spaces”, “space”, “forward_lang”, “backward_lang”, “distance_to_letter”, “repeat_letter_lang”, and “rest lang” are variables holding the language used for the map encoding scheme as described above. This language can change for each map puzzle entered into the system. Each record in table 1810 may have the following fields: an id to serve as a unique identifier for each record, “product_letter_id” to designate which letter in a product is to include which puzzle stuff as determined by “puzzle_stuff_id.”

A product cipher table 1806 in FIG. 18B stores records for each cipher puzzle in the system. Each record in table 1806 may have the following fields: an indicating a unique identifier for each cipher puzzle, a “product id” linking each cipher puzzle to a specific product, a cipher name in text for display in the admin section of the web site, a “cipher version” to track a particular mapping of numbers and letters as described above, a “key_path” which indicates the location of a cipher key and solution for the puzzle, a “letter_separater” and “no_of separators” are used to indicate the encoding scheme as described above, “a”-“z” provides a set of mappings of letters to numbers that correspond with the “cipher_version”.

Each time a giver configures an adventure for a recipient, an order record is created in an orders table 1811 in FIG. 18D. Each record in table 1811 may have the following fields: an id for a unique identifier for each adventure order, a “product_id” to record which product has been ordered, an “order_id” to determine which order the said adventure order is part of (there may be multiple adventure orders in a single credit card transaction order), a “recipient_address” to indicate the mailing address to be put on the letters in the case that the address stored in the address book is not used, the “product_cost” and “shipping_cost” is the cost of the adventure, the “present” is a place to predefine the present in case it isn't generated (e.g., Easter chocolate on Easter), the “puzzle_id” indicates which puzzle is associated with the product in case there are multiple puzzle choices per product, the “user defined target date” is to store a date request in the case the user wants to delegate the delivery timing decision to the system and has a requested date for the adventure to occur, the “other_person_hiding_gift” field is used to store whether someone else is in charge of hiding the gift (e.g., a third party coordinator), the “gift location” is the hiding place for the gift (i.e., the message location) the sender chose during ordering, the “delivery_option” indicates the methodology chosen by the sender during purchase as indicated in above (e.g., sequential or packaged), “is_open_ended” is a toggle to determine this type of delivery option, “character_id” determines which character has been selected for the adventure, “guardian_name” is to indicate the name the package is sent to as indicated in above (e.g., the name of the third party coordinator), “product_country_shipping_id” is used to determine appropriate shipping charges that might vary by country.

FIG. 18E shows the flow leading to the final transaction of an order. Letter recipients table 1812 links to the address books table 1813, which links to the users who own the address book in users table 1814, which links to the order information described in orders table 1815, which, once payment is complete, lead to a record in the payments table 1816. Each record in table 1812 may have the following fields: an id for a unique identifier for each record and a list of each “address_book_id” representing each recipient of the adventure to the adventure itself as described in “order product_id.” Each record in table 1813 will have a “user_id” to associate the record with a user and the following descriptive fields to populate the address book: “first_name”, “last_name”, “address”, “address2”, “city”, “state”, “zip”, “country”, “birth_date”, “age”, “email”, and “gender.” Each record in table 1814 represents a user who has an account on the web site who purchases an adventure for a recipient. Fields include “first_name”, “last_name”, “email”, “password”, “salt” for encrypting passwords, and optional address fields for that user. Each record in table 1815 may have the following fields: “user_id” linking the order to a user, “promo_discount_id” linking the order to a discount code, “is completed” designating whether the order has been completed, “start_date” indicating when the adventure is scheduled to start, “total_amount” holding the total order amount to be paid, “is_paid” indicates whether the order has been paid, “shipping_cost” indicates the shipping cost portion of the total order, and address fields for credit card transactions. Each record in table 1816 may have the following fields: “order_id” indicating the order the record is linked to, “trans_id” is a transaction id from a 3^{rd}-party credit card processor, “transaction_date” is the timestamp for the order, “creditcard” is the last 4 digits of the credit card used for the transaction, and “acknowledgement” contains any special messages received from the 3^{rd}-party credit card processor.

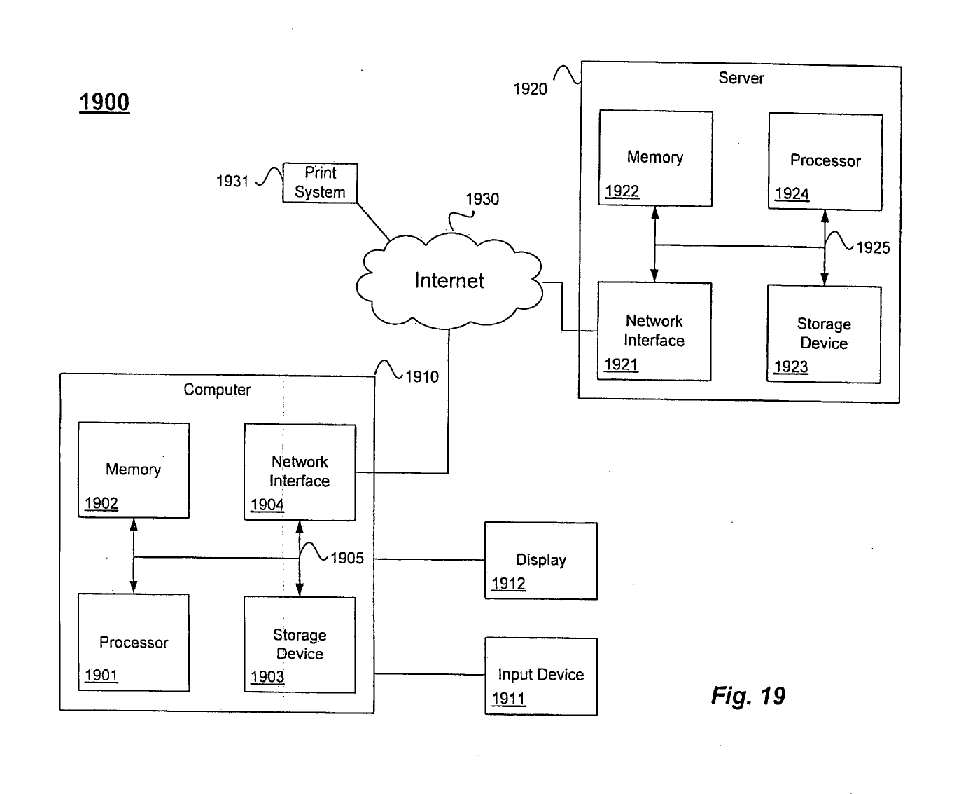

FIG. 19 illustrates computer implemented system according to one embodiment of the present invention. Computer implemented system 1900 may include one or more computers such as desktop computers, laptop computers, handheld computing devices, or servers, for example. One computer system 1910 includes a bus 1905 for communicating information between a processor 1901, memory 1902, storage device 1903 and a network interface 1904. Memory 1902 is coupled to bus 1905 for storing information and instructions to be executed by processor 1901, including instructions for performing the techniques described above. Possible implementations of this memory may be, but are not limited to, random access memory (RAM), read only memory (ROM) or both. A storage device 1903 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage devices 1903 and memory 1902 are examples of computer readable mediums for storing software comprising instructions for implementing the techniques described above.

Computer system 1910 may be coupled via bus 1905 to a display 1912, such as a cathode ray tube (CRT) or liquid crystal display (LCD), for displaying information to a computer user. An input device 1911 such as a keyboard and/or mouse is coupled to bus 1905 for communicating information and command selections from the user to processor 1901. The combination of these components may allow the user to communicate with the system.

Computer system 1910 also includes a network interface 1904 coupled with bus 1905. Network interface 1904 may provide two-way data communication between computer system 1910 and a network such as the Internet 1930. The network interface 1904 may be a wired or wireless interface, for example. In any such implementation, network interface 1904 sends and receives electrical, electromagnetic, or optical signals that carry digital data streams representing various types of information.

Computer system 1910 can send and receive information, including the information described above, through the network interface 1904 to the Internet 1930. In the Internet example, electronic materials described above may reside on multiple different servers 1920 across the network. The database including the records and other information described above may reside on one or more servers in memory 1922 and/or storage 1923. Processor 1924 may control the interaction of the web pages with users and may perform the processes described above including, but not limited to, generating print control documents and encoding locations, for example. Each server may include a bus 1925, memory 1922, processor 1924, storage device 1923, and network interface 1921. For example, a giver may select activities, adventures, letters, or characters on the server 1920 and enter information to be stored on the server, for example. The server 1920 may transmit print controls across the Internet 1130 to printing system 1931.

### Further Giftventure Example

Embodiments of the present invention provide a way to take what historically was a very local activity—creating a scavenger or treasure hunt in your backyard—and allow someone to order an adventure online complete with mythical characters, personalized props, puzzles and mysteries, for example. The system to deliver such a service may manage general variables, such as storylines, and allow personalized and local information to be dynamically included in the story.

The system

A Giftventure is a customized adventure around a present, event, or holiday. It can take less than five minutes for the giver to order, but the adventure can last for weeks for the recipient. The Giftventure system may include:
A system to deliver a customized adventure story created around a gift, event, or holiday for a recipient.
A system to deliver customized puzzles to go with the adventure story created around a gift, event, or holiday for a recipient.
A centralized system that creates customized scavenger hunts, treasure hunts, and adventures or other activities with storylines customized to specific individuals with information about their specific environment, distributed in different geographic locales. For example, a user might choose a location to hide a present (“The Location”), enter it into a web site with an order. A series of materials, letters, website landing pages, phone calls, text messages, IM messages, real-world props, etc., is dynamically generated and sent to the recipient of the adventure over a period of time.
An interface option for the giver to specify the adventure ending date. For instance, the giver can specify whether there is a hard stop date for the adventure, such as on a birthday.
An interface that allows the giver to specify different puzzle difficulty levels based on their preference or based on the capabilities of the recipient.
Multiple puzzle types are available.
“The Location” or other message is determined by the giver and input into a web site.
“The Location” is dynamically embedded into the adventure story and/or on the puzzles.
The puzzles may be delivered to the recipient by the same or different delivery mechanisms (US postal mail, internet, phone, clues from parents, etc.)
The puzzles may be delivered staggered over time, and the delivery dates and methodologies can be configured on a web-site interface by the giver or are determined by the service provider based on convenience of shipping.
The web site interface has a tracking mechanism to allow the giver to see the states of the adventure and puzzle solving at any point in time.
Clues are generated for the recipient.

Adventure Story Content

The system may include algorithms and interfaces to allow for dynamic adventure story creation based on specific individual's location and social grouping. For example, if ten families in one school order the same product, different stories endings may be giving to different children so the stories don't repeat. Also, for example, an adventure could require collaboration with individuals from the same school (or other social grouping) to solve the puzzle. Further, an alert system (e.g., “to do” list) may be used to show giver where a particular recipient is in a series of adventures, to make sure the recipient doesn't receive the same one twice. The system may generates dynamic stories based on certain information about an individual who is the recipient of the story. For example, if a recipient has a dog named ‘spot’, a story might contain a scene where a mythical character, such as a unicom, recalls a conversation with ‘spot’. The effect is a high degree of personalization and emotional connection for the user. The interface may allow the giver to note whether the storyline has already been introduced to a recipient, so the characters can speak in second person in a familiar voice, since they have already been introduced. An algorithm may automatically checks whether the above case is true, eliminating the need for the giver to use the interface.

An interface may allow for 3^{rd}-party content companies to create their own adventure stories and puzzles around their own proprietary content. A database billing system may allow revenue to be share with such a 3^{rd}-party. An interface may allow a giver to specify whether the giver will be near the recipient or away from the recipient when they receive the adventure. Customization of the puzzles and the stories happen based on the answer. Giftventure content dictates at least two types of common giving situations: (1) Giver lives with child and sees them every day (Parents, siblings, etc.) or (2) Giver is remote from child and will not see the child for the duration of the Giftventure (grandparents, uncles, aunts, parents on business trips, etc.). For example, if the storyline is “I am climbing the Himalayas in pursuit of a mad yak with your present tied to its hoof by a string”, it wouldn't work well if the child sees you standing there. That sensational storyline would go very well with someone who is away. For the remote giver, telephone and email correspondence is supported.

Some embodiments may support ecommerce. For example, one embodiment of the present invention includes a system and interface to make product recommendations based on adventure story content and personalized information.

Applications to Enhance Storyline

Frequently, a recipient may want to communicate with the mythical characters that send clues. An email forwarding and alias system may be used to masquerade the giver as a fictional character, to allow for a greater degree of personalization of the adventure. The email masquerade system would allow a giver to masquerade as the fictional character and provide an infinite level of personalized detail to draw the recipient into the story at a greater level than otherwise possible. An example would be a child who receives a letter from a dragon about a missing present. The child sends an email to the dragon. The system routes this email to the child's mother, who can respond with details particular to her child's life. Such as, “you will find your present if you eat all your vegetables tonight.” The response is sent from the system that masquerades the mother's email as the dragon's email address, so the child thinks the response came from the dragon itself.

Puzzle Manufacturing

In one embodiment, the system may break up items into multiple pieces for re-assembly to solve a puzzle. The item has the puzzle answer embedded in it, or it is part of a larger puzzle. One example of an assembly line process and apparatus for jigsaw puzzle clue delivery is as follows: (1) printer prints the dynamic data of “the location” on the back of a piece of puzzle-grade cardboard with the picture already attached to the front side, (2) Jigsaw puzzle die and press that cuts the puzzle into pieces, (3) the jigsaw pieces are divided into three, or some other configurable number, of flat piles. Each pile has the same or pre-determined number of pieces, (4) a “package” of each group of flat puzzle pieces is created by “wrapping”, for example, the pieces in saran wrap and/or very light cardboard, for example. In one embodiment, the package pieces may be maintained flat. First, better postal rates are obtained if the whole envelope is ¼″ thick or less, but the puzzle pieces should not double up on each other in the envelope. Second, from a handling perspective, mail stuffers will have a much better chance with a clean insert than trying to track and handle individual puzzle pieces. Finally, a process may be employed so that the puzzle piece groups “meet up” with the appropriate letters and envelops so they get stuffed properly.

Example Web Site

Welcome! Imagine the surprise of a child who receives a signed letter in the mail from Santa's elves, from a notorious pirate on the loose, or from a fantastic princess surrounded by fairies and unicorns. Embodiments of the present invention allow these letters to arrive, with real world clues and trinkets about an important mystery that needs to be solved. There is a call to action. Solving the mystery may lead to something precious: a present. Embodiments of the present invention include a “Giftventure” web based system. A Giftventure is a customized adventure around a present, event, or holiday. It takes less than five minutes for the giver, but the adventure can last weeks for the recipient. Rather than just “give” your present the old fashioned way, a mystery is announced by a series of letters addressed to the child. The mystery is complete with magical characters, sinister villains, real-world props, puzzles, and clues. The child plays protagonist, taking an active role and helping shape the outcome of the story. The reward of solving the mystery is the gift itself. Like the plot of a movie, the child experiences ups and downs. Ultimately, the child solves the mystery and earns a profound sense of accomplishment as well as the present. The child exercises patience, problem solving, and imagination, all while being entertained as the central figure in a real-world mystery. The characters and difficulty of each Giftventure may be tailored to the age level and interests of the recipient. A Giftventure experience is governed by a series of letters. One example product may include four letters over two weeks. The system causes customized letters to be sent to the child.

| | |
|---|---|
| Letter#1 | Introduction of plot and |
| | announcement there is a missing |
| | present for the child. Clue #1 |
| | included. |
| Letter#2 | Plot development with clue#2 |
| | included |
| Letter#3 | Plot development with clue#3 |
| | included |
| Letter#4 | Plot concluded with final clue |
| | necessary for child to find missing |
| | present. |

As described above, the letters may be from the giver or from a character, such as Santa Claus, Simon the Unicom, etc. Each Giftventure storyline is tailored to reflect the appropriate sender. Each letter may contain some, or optionally all, of the clues necessary to solve the mystery. Puzzles may include jigsaw puzzles or cipher puzzles, for example, or many others. The child may accumulate all the clues to find the present. The location of the present may be integrated in the clues. The giver may pick a place accessible by the child to hide the present. The giver includes that location when ordering the Giftventure on the website. A custom Giftventure is created with the location incorporated into the puzzles automatically. Based on the giver's preference, we can include a clue on our web site as part of the adventure. However, some parents prefer Internet involvement and some don't. Mailers may be generated automatically for non-Internet applications. Any present and any occasion may supplemented with a Giftventure: Birthday and Christmas presents, presents from visiting relatives, presents from parents returning from business trips when they've been away, presents from distant relatives, who can't physically be there for an occasion, or a late present. The presents may be provided by the giver, a third party coordinator, or in some embodiments purchase on the website with the adventure.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
storing a plurality of activity records;
storing a plurality of first text elements;
storing a plurality of template letters, each template letter including a plurality of fillable fields;
receiving a plurality of customized text elements from a user and a selection of a first activity record from said plurality of activity records;
associating a plurality of said template letters with the first activity;
associating one or more of said first text elements and said customized text elements with the first activity;
generating a print control document for controlling the printing of said template letters, wherein the one or more first text elements and the customized text are used to fill the fields of the template letters.

2. The method of claim 1 further comprising receiving a name and address of a recipient different from the user, wherein the print control document includes the name and address of the recipient for generating one or more mailers to said recipient.

3. The method of claim 1 further comprising receiving a message from the user, wherein the print control document includes said message and said message is included in at least one of said mailers.

4. The method of claim 3 wherein the message is encoded.

5. The method of claim 3 wherein the message is an encoded location.

6. The method of claim 3, the print control document comprising a plurality of fields, wherein the message is stored in one of said fields.

7. The method of claim 3, the print control document comprising a plurality of fields, wherein an encoded representation of the message is stored in a plurality of said fields.

8. The method of claim 3 further comprising storing references to a plurality of images, wherein at least one image is associated with one or more of said template letters to be printed for printing on said template letters based on information received from said user, and at least one other image is associated with the activity record selected by the user to be printed and mailed with one or more of said template letters.

9. The method of claim 8 wherein the information received from said user is selection of a character from a plurality of characters, and wherein the at least one other image is a puzzle.

10. The method of claim 9 further comprising storing a plurality of character records corresponding to said plurality of characters, each character record being associated with an activity record based on said selection of a character by the user.

11. The method of claim 10 further comprising storing a number in each activity record, the number specifying the number of template letters associated with each activity record for sending to the recipient.

12. The method of claim 11 wherein said number is greater than 1, and wherein a plurality of template letters associated with an activity record each have an associated template image and puzzle image.

13. A computer-implemented method comprising:
storing a plurality of text template letters in a database, each text template letter including a plurality of fillable fields;
storing references to a plurality of template images in the database, each template image configured for printing with a corresponding text template letter;
storing references to a plurality of graphic images in the database;
storing a plurality of character records in a database, each character record being associated with a plurality of text fields corresponding to a character;
storing a plurality of adventures records in a database, each adventure record being associated with one or more character records, a plurality of text template letters, a plurality of template images, and a plurality of graphic images;
receiving a user selection of an adventure corresponding to a first adventure record from the plurality of adventure records and a character corresponding to a first character record from the character records associated with the first adventure record, and in accordance therewith, associating the first character record with the first adventure record;
receiving customize text corresponding to a recipient; and
generating a plurality of print controls for producing mailings to the recipient, wherein the print controls specify that one or more of said mailings includes at least one text template letter superimposed with at least one template image, wherein the fillable fields of the at least one text template letter are filled with said customized text and one or more text fields from said character record, and wherein the at least one text template letter is mailed with at least one other printed graphic image.

14. The method of claim 13 wherein the graphic image is a puzzle.

15. The method of claim 13 further comprising receiving a location from a user and encoding the location in the print controls for printing on a piece of material with said graphic image.

16. The method of claim 15, the encoding comprising mapping from a first font to a second font.

17. The method of claim 13 further comprising storing first text for filling in a first field of a first template letter when a character record is associated with a first adventure record, and storing second text for filling in a first field of a second template letter when the character record is associated with a second adventure record.

18. The method of claim 13 further comprising:
storing a familiarity designation corresponding to a character for the recipient; and
mapping first text to a fillable field of a text template letter if the character is designated as familiar, and mapping second text to the fillable field of the text template letter if the character is designated as not familiar.

19. The method of claim 13 wherein a first fillable field in the text template letter associated with the first adventure record is filled in with at least a portion of the customized text corresponding to the recipient received from the user, and wherein a second fillable field in the text template letter associated with the first adventure record is filled in with a first text field of a character record associated with the first adventure record.

20. The method of claim 13 wherein the print controls comprise one or more print control documents comprising a plurality of records, each record including a field with a specification of a text template letter to be printed corresponding to a user selected adventure, a plurality of fields each with at least a portion of the customized text corresponding to the recipient received from the user, one or more fields including a reference to a template image, one or more fields including a reference to a graphic image.

21. The method of claim 20 wherein the print control documents each include a plurality of records corresponding to mailers to send on the same day, wherein the customized text corresponding to the recipient comprises the name of the recipient and the address of the recipient.

22. The method of claim 13 wherein each adventure record comprises a plurality of template letters and graphic images, and wherein at least one filled in template letter and at least one graphic image are sent together on a plurality of different days.
